(19) United States
(12) Patent Application Publication
(10) Pub. No.: US 2016/0165246 A1
(43) Pub. Date: Jun. 9, 2016

(54) IMAGE PROCESSING DEVICE AND METHOD

(71) Applicant: SONY CORPORATION, Tokyo (JP)

(72) Inventors: TAKEFUMI NAGUMO, KANAGAWA (JP); YUJI ANDO, KANAGAWA (JP); NOBUAKI IZUMI, KANAGAWA (JP)

(21) Appl. No.: 14/900,866

(22) PCT Filed: Jul. 8, 2014
(86) PCT No.: PCT/JP2014/068124

§ 371 Date: Dec. 22, 2015

(30) Foreign Application Priority Data
Jul. 17, 2013 (JP) 2013-148437

(51) Int. Cl. H04N 19/44; H04N 19/124; H04N 19/553; H04N 19/176; H04N 19/184; H04N 19/30; H04N 19/117; H04N 19/139

(52) U.S. Cl. CPC H04N 19/44; H04N 19/117; H04N 19/124; H04N 19/139; H04N 19/176; H04N 19/184; H04N 19/30; H04N 19/553

(57) ABSTRACT

The present disclosure relates to an image processing device and a method thereof which enable a high image quality process with higher efficiency.

A decoding section outputs, in addition to a decoded image, hierarchical block split information of a CU, a PU, and a TU to an image processing section as motion vector information and image split information that are encoded information included in a bit stream used in decoding. The image processing section specifies a dynamic body area from the decoded image supplied from the decoding section using the hierarchical block split information that is the encoded information from the decoding section, and performs a high image quality process. The present disclosure can be applied to, for example, an image processing device which performs a high image quality process on a decoded image that has been decoded.

### TECHNICAL FIELD

The present disclosure relates to an image processing device and method, and particularly to an image processing device and method which enable a high image quality process with higher efficiency.

### BACKGROUND ART

After bit streams delivered through broadcasting, DVDs, and the like are decoded, a high image quality process such as noise reduction, a frame number interpolation process (high frame-rate process), or a multi-frame super resolution process is performed thereon. For such a high image quality process, detection of a motion or identification of a dynamic body area is performed on a decoded image which is the decoding result of the bit streams.

In other words, dynamic image data is generally transmitted in the form of bit streams and decoded to image information by a decoder. Such a decoder decodes bit streams of a dynamic image according to a prescribed image decoding method such as MPEG-2, MPEG-4, MPEG-4AVC, or HEVC to generate an image. Then, detection of motions is performed on a decoded image by a motion detector, detection of dynamic body areas is performed, and the results are supplied to a high image quality processing section of a later stage (see Patent Literature 1).

### CITATION LIST

### Patent Literature

Patent Literature: JP 3700195B

### SUMMARY OF INVENTION

### Technical Problem

Here, even though various kinds of encoded information are actually decoded by a decoder, detection of motions, detection of dynamic body areas, and the like are performed again in a later stage of the decoder in most cases.

The present disclosure takes the above circumstances into consideration and aims to enable a high image quality process to be performed more efficiently.

### Solution to Problem

An image processing device according to an aspect of the present disclosure includes: an image processing section configured to perform image processing on an image generated by performing a decoding process on a bit stream in units of blocks which have a hierarchical structure using an encoding parameter to be used in performing encoding in units of blocks which have a hierarchical structure.

The encoding parameter is a parameter which indicates a size of a block.

The encoding parameter is a parameter which indicates a depth of a layer.

The encoding parameter is split-flag.

The encoding parameter is a parameter of an adaptive offset filter.

The encoding parameter is a parameter which indicates edge offset or band offset.

The image processing section can perform image processing using an encoding block size map generated from the encoding parameter.

The image processing section can include an area detecting section configured to generate area information by detecting a boundary of an area from the encoding parameter, and a high image quality processing section configured to perform a high image quality process on the image based on the area information detected by the area detecting section.

The area detecting section can generate area information which includes information that indicates a dynamic body area or a standstill area.

The area detecting section can generate the area information using motion vector information obtained by performing a decoding process on the bit stream.

The image processing section can further include an area deciding section configured to generate area information which indicates an occlusion or an excessively deformed area from the encoding parameter. The high image quality processing section can perform a high image quality process on the image based on the area information detected by the area detecting section and the area information generated by the area deciding section.

The high image quality process is a process which uses an in-screen correlation.

The high image quality process is noise reduction, a high frame-rate process, or a multi-fame super resolution process.

The image processing section can include an area deciding section configured to generate area information which indicates an occlusion or an excessively deformed area from the encoding parameter, and a high image quality processing section configured to perform a high image quality process on the image based on the area information decided by the area deciding section.

The image processing device can further include: a decoding section configured to perform a decoding process on the bit stream to generate the image and output the encoding parameter. The image processing section can perform image processing on an image generated by the decoding section using the encoding parameter output by the decoding section.

The decoding section can further include an adaptive offset filtering section configured to perform an adaptive offset process on the image.

An image processing method according to an aspect of the present disclosure includes: performing, by an image processing device, image processing on an image generated by performing a decoding process on a bit stream in units of blocks which have a hierarchical structure, using an encoding parameter to be used in performing encoding in units of blocks which have a hierarchical structure.

According to an aspect of the present disclosure, image processing is performed on an image generated by performing a decoding process on a bit stream in units of blocks which have a hierarchical structure, using an encoding parameter to be used in performing encoding in units of blocks which have a hierarchical structure.

Also, the above-described image processing device may be an independent device or an inner block constituting one image decoding device.

### Advantageous Effects of Invention

According to the present disclosure, an image can be decoded. Particularly, a high image quality process can be performed more efficiently.

It should be noted that effects described in the present specification are merely illustrative, and effects of the present technology are not limited to the effects described in the present specification and there may be additional effects.

### BRIEF DESCRIPTION OF DRAWINGS

FIG. 1 is a block diagram showing a configuration example of an image processing device which has a motion detector.

FIG. 2 is a block diagram showing a configuration example of another image processing device which uses encoded information.

FIG. 3 is a diagram for describing a hierarchical structure.

FIG. 4 is a block diagram showing a configuration example of a decoding section.

FIG. 5 is a diagram showing an example of syntax of a CTU.

FIG. 6 is a diagram showing an example of syntax of coding_quadtree.

FIG. 7 is a diagram showing an example of semantics of split_cu_flag.

FIG. 8 is a diagram for describing a parsing method of a PU size.

FIG. 9 is a diagram for describing the parsing method of a PU size.

FIG. 10 is a diagram showing an example of semantics of part_mode.

FIG. 11 is a diagram for describing a parsing method of a TU size.

FIG. 12 is a diagram showing an example of semantics of split_transform_flag.

FIG. 13 is a block diagram showing a configuration example of a dynamic body area detector.

FIG. 14 is a diagram showing an example of block split and a boundary candidate.

FIG. 15 is a flowchart describing image processing.

FIG. 16 is a flowchart describing a decoding process.

FIG. 17 is a flowchart describing a dynamic body area characteristic process.

FIG. 18 is a diagram for describing the dynamic body area process.

FIG. 19 is a diagram for describing the dynamic body area detecting process.

FIG. 20 is a diagram for describing an occlusion area.

FIG. 21 is a diagram for describing SAO.

FIG. 22 is a block diagram showing another configuration example of the image processing device which uses encoded information.

FIG. 23 is a block diagram showing a configuration example of an area splitting section.

FIG. 24 is a block diagram showing a configuration example of an object boundary detector.

FIG. 25 is a flowchart describing image processing.

FIG. 26 is a flowchart describing an area splitting process.

FIG. 27 is a diagram for describing the area splitting process.

FIG. 28 is a diagram for describing the area splitting process.

FIG. 29 is a flowchart describing an object boundary detection process.

FIG. 30 is a flowchart describing a detection process of a time-axis-process non-adaptive area.

FIG. 31 is a flowchart describing a time-axis-processed-area decision process.

FIG. 32 is a diagram for describing the time-axis-processed-area decision process.

FIG. 33 is a diagram for describing a method for using a time-processed-area map.

FIG. 34 is a block diagram showing a main configuration example of a computer.

FIG. 35 is a block diagram showing an example of a schematic configuration of a television.

FIG. 36 is a block diagram showing an example of a schematic configuration of a mobile telephone.

FIG. 37 is a block diagram showing an example of a schematic configuration of a recording and reproduction device.

FIG. 38 is a block diagram showing an example of a schematic configuration of an imaging device.

FIG. 39 is a block diagram showing an example of a schematic configuration of a video set.

FIG. 40 is a block diagram showing an example of a schematic configuration of a video processor.

FIG. 41 is a block diagram showing another example of the schematic configuration of the video processor.

### DESCRIPTION OF EMBODIMENTS

Hereinafter, embodiments for implementing the present disclosure (which will be referred to as embodiments) will be described. It should be noted that description will be provided in the following order.

1. First embodiment (example of an image processing device which uses hierarchical block split information)

2. Second embodiment (example of an image processing device which uses SAO parameters)

3. Third Embodiment (computer)

4. Application examples

5. Fourth Embodiment (set, unit, module, and processor)

### First Embodiment

### Configuration Example of an Image Processing Device

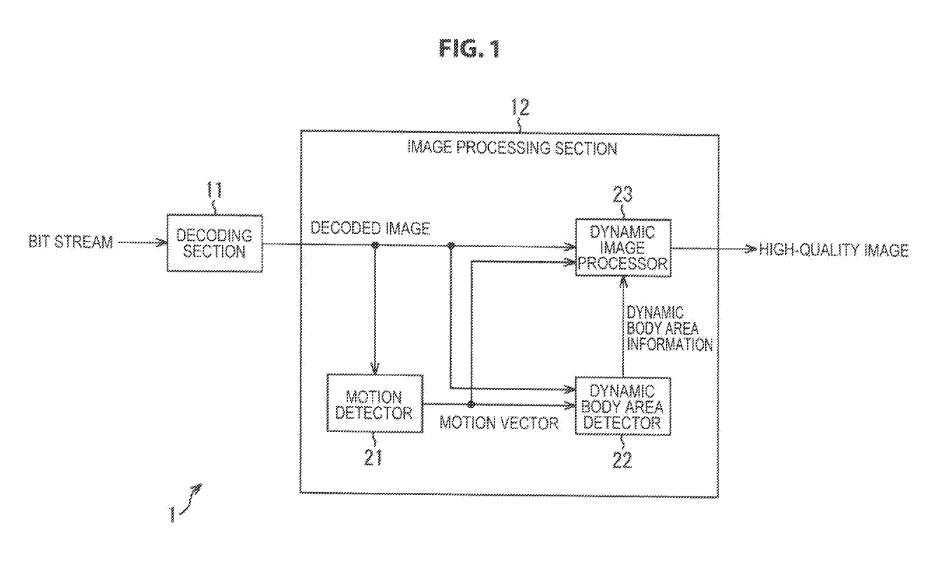

FIG. 1 is a block diagram showing a configuration example of an image processing device which has a motion detector. In the example of FIG. 1, the image processing device 1 is an image processing device which performs a high image quality process after decoding bit streams delivered through broadcasting, DVDs, or the like.

The image processing device 1 includes a decoding section 11 and an image processing section 12. The image processing section 12 includes a motion detector 21, a dynamic body area detector 22, and a dynamic image processor 23.

The decoding section 11 receives input of bit streams, decodes the input bit streams according to a prescribed image decoding method, and thereby generates a decoded image. Such image decoding methods include Moving Picture Experts Group (MPEG)-2, MPEG-4, MPEG-4 Advanced Video Coding (AVC; which will be hereinafter referred to simply as AVC), High Efficiency Video Coding (HEVC), and the like. The decoded image generated by the decoding section 11 is output to each of the motion detector 21, the dynamic body area detector 22, and the dynamic image processor 23.

The motion detector 21 performs detection of a motion vector from the decoded image supplied from the decoding section 11. As motion vector detection methods, there are a plurality of algorithms such as block matching and optical flow. There is no limitation on a motion vector detection method in the example of FIG. 1. The motion vector detected by the motion detector 21 is output to the dynamic body area detector 22.

The dynamic body area detector 22 performs specification of a dynamic body area using the motion vector detected by the motion detector 21 and the decoded image from the decoding section 11. For example, the dynamic body area detector 22 identifies an area such as a ball moving in the image in a frame number interpolation process (high frame-rate process). The dynamic body area detector 22 supplies information of the specified dynamic body area to the dynamic image processor 23.

The dynamic image processor 23 performs a process which uses an in-screen correlation such as noise reduction, the frame number interpolation process, or a multi-frame super resolution process as a high image quality process. The dynamic image processor 23 outputs an image which has been processed to have high image quality to the later stage that is not illustrated.

It should be noted that, although not illustrated, when a frame buffer or the like for accumulating frames of the past is necessary for the motion detector 21, the dynamic body area detector 22, and the dynamic image processor 23 in the example of FIG. 1, each of the blocks is assumed to include one.

As described above, in the image processing device 1, the high image quality process is performed on the image decoded by the decoding section 11. In addition, even though various kinds of encoded information are decoded by the decoding section 11 in practice, the information is not used and a motion vector or the like is detected by the motion detector 21 again in the later stage of the decoding section 11 in the image processing device 1, which incurs costs.

[Configuration Example of Another Image Processing Device]

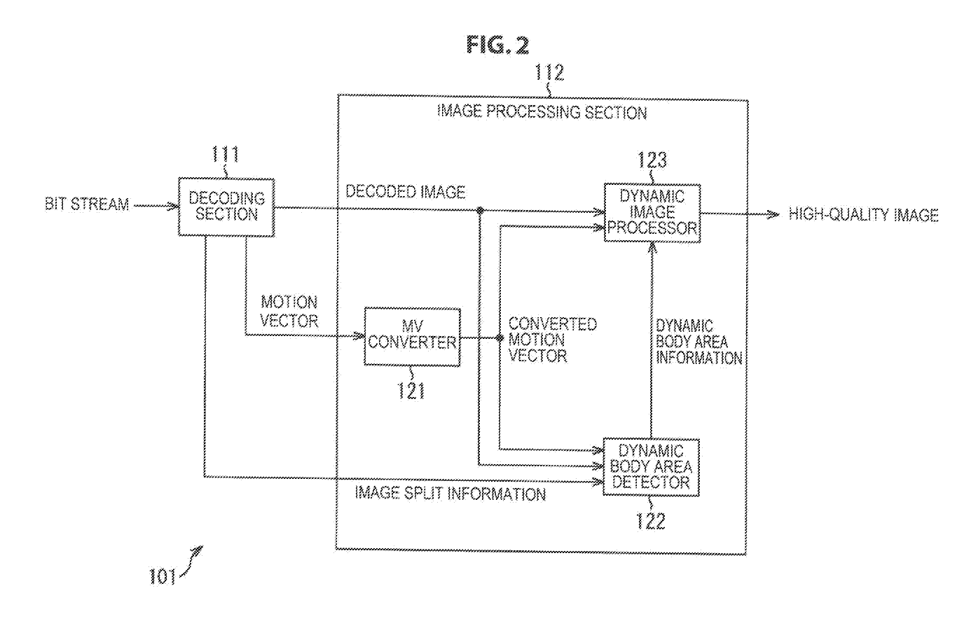

FIG. 2 is a block diagram showing a configuration example of another image processing device which uses encoded information. In the example of FIG. 2, the image processing device 101 is an image processing device which performs a high image quality process after bit streams delivered through broadcasting, DVDs, or the like are decoded, like the image processing device 1 of FIG. 1.

In the example of FIG. 2, the image processing device 101 includes a decoding section 111 and an image processing section 112.

The decoding section 111 is a decoder based on, for example, the standard of High Efficiency Video Coding (HEVC), and receives input of bit streams encoded according to HEVC from the outside which is not illustrated. The decoding section 111 decodes the input bit streams according to the HEVC standard.

The decoding section 11 of FIG. 1 only outputs a decoded image to the image processing section 12 of the later stage. On the other hand, the decoding section 111 of FIG. 2 outputs, in addition to the decoded image, motion vector information which is encoded information included in the bit streams used in the decoding and hierarchical block split information such as a coding unit (CU), a prediction unit (PU), or a transform unit (TU) (which will also be referred to as quadtree information) as image split information to the image processing section 112. In the decoding section 111, the encoded information included in the bit streams used in the decoding is, in other words, encoded information (a parameter) used when it is encoded in a unit that has a hierarchical structure.

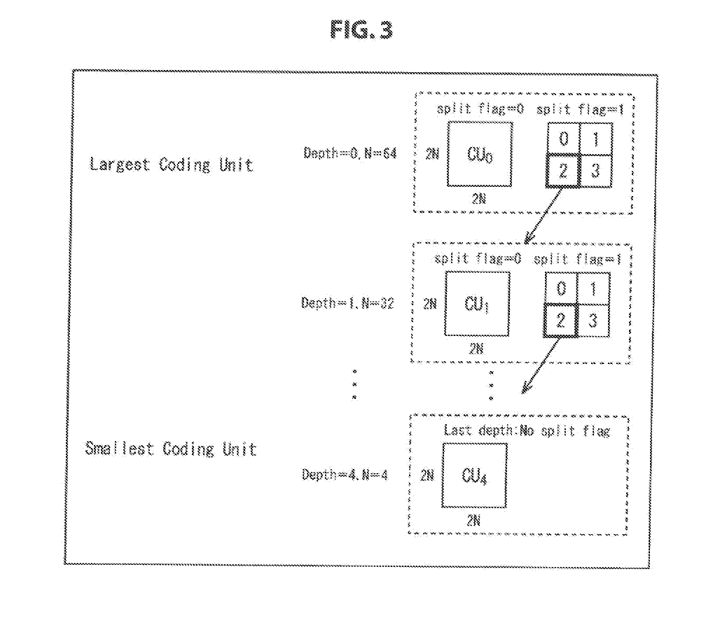

The hierarchical block split information is a parameter that indicates the size of a block and indicates the depth of the hierarchy. To be specific, the hierarchical block split information is split-flag that will be described below. Here, a CU, a PU, and a TU will be described with reference to FIG. 3.

In an AVC scheme, a hierarchical structure based on a macroblock and a sub macroblock is defined. However, a macroblock of 16×16 pixels is not optimal for a large image frame such as a Ultra High Definition (UHD) (4000×2000 pixels) serving as a target of a next generation encoding scheme.

On the other hand, in HEVC, a coding unit (CU) is defined as shown in FIG. 3. While the hierarchical structure of AVC is referred to as a block coding structure, the hierarchical structure of HEVC is referred to as a quadtree coding structure.

A CU is also referred to as a coding tree block (CTB), and serves as a partial area of an image of a picture unit undertaking the same role of a macroblock in the AVC scheme. The latter is fixed to a size of 16×16 pixels, but the former is not fixed to a certain size but designated in image compression information in each sequence.

For example, a largest coding unit (LCU) and a smallest coding unit (SCU) of a CU are specified in a sequence parameter set (SPS) included in encoded data to be output.

As split-flag=1 is set in a range in which each LCU is not smaller than an SCU, a coding unit can be split into CUs having a smaller size, and it is possible to know into what size the unit can be split. In the example of FIG. 3, a size of an LCU is 128, and a largest scalable depth is 5. A CUI of a size of 2N×2N is split into CUs having a size of N×N serving as a layer that is one-level lower when a value of split_flag is 1.

Further, a CU is split into prediction units (PUs) that are areas (partial areas of an image of a picture unit) serving as processing units of intra or inter prediction. A PU is split into transform units (TUs) that are areas (partial areas of an image of a picture unit) serving as processing units of orthogonal transforms. Currently, in the HEVC scheme, in addition to 4×4 and 8×8, orthogonal transforms of 16×16 and 32×32 can be used. In other words, a CU is hierarchically split in units of blocks, and a TU is hierarchically split from a CU.

In an encoding scheme in which a CU is defined and various kinds of processes are performed in units of CUs as in the HEVC scheme, it can be considered that a macroblock of the AVC scheme corresponds to an LCU and a block (subblock) corresponds to a CU. Further, a motion compensation block of the AVC scheme can be considered to correspond to a PU. Here, since a CU has a hierarchical structure, a size of an LCU of a topmost layer is commonly set to be larger than a macroblock of the AVC scheme, for example, such as 128×128 pixels.

Thus, hereinafter, an LCU is assumed to include a macroblock in the AVC scheme, and a CU is assumed to include a block (subblock) in the AVC scheme. In other words, a “block” used in the following description indicates an arbitrary partial area included in a picture, and, for example, a size, a shape, and characteristics thereof are not limited. In other words, a “block” includes an arbitrary area (a processing unit) such as a TU, a PU, an SCU, a CU, an LCU, a subblock, a macroblock, or a slice. Of course, a “block” includes other partial areas (processing units) as well. When it is necessary to limit a size, a processing unit, or the like, it will be appropriately described.

In addition, in the present specification, a coding tree unit (CTU) is assumed to be a unit which includes a coding tree block (CTB) of an LCU (a CU having a largest value) and a parameter used when processing is performed with an LCU base (level) thereof. In addition, a coding unit (CU) constituting a CTU is assumed to be a unit which includes a coding block (CB) and a parameter used when processing is performed with a CU base (level) thereof.

Returning to FIG. 2, the image processing section 112 specifies a dynamic body area and performs the high image quality process on the decoded image from the decoding section 111 using the encoded image from the decoding section 111. The image processing section 112 includes an MV converter 121, a dynamic body area detector 122, and a dynamic image processor 123. It should be noted that, although not illustrated in the drawing, when a frame buffer or the like for accumulating frames of the past is also necessary for the dynamic body area detector 122 and the dynamic image processor 123 in the example of FIG. 2, each of the blocks is assumed to include one.

The MV converter 121 performs normalization in the direction of an encoding order to a display order or the like based on the motion vector information from the decoding section 111, performs signal processing, and thereby converts the information into a motion vector available for respective sections in the later stage. The MV converter 121 supplies the converted motion vector to the dynamic body area detector 122 and the dynamic image processor 123.

The decoded image from the decoding section 111 is input to the dynamic body area detector 122 and the dynamic image processor 123. In addition, the image split information (hierarchical block split information) from the decoding section 111 is input to the dynamic body area detector 122.

The dynamic body area detector 122 performs specification of a dynamic body area using the encoded information from the decoding section 111, i.e., the hierarchical block split information, the motion vector, and the information of the decoded image.

For a CU size or a TU size generally selected at the time of encoding of HEVC, a large block is likely to be selected when a feature amount of an image is uniform, and a small block size is likely to be selected in a spot in which features of an image are not uniform such as an object boundary part.

The dynamic body area detector 122 performs determination of an area using the above property of HEVC streams. The dynamic body area detector 122 creates a block size map which shows a split position in an image using the information of a CU size obtained as the hierarchical block split information.

The dynamic body area detector 122 specifies a block position split in a fixed size or smaller based on the information of the created block size map, links the block to an adjacent small-sized block, and thereby generates object boundary position information. Then, the dynamic body area detector 122 integrates remaining blocks based on the generated object boundary position information to perform labeling in units of objects (object), and thereby generates area information in units of objects.

It should be noted that when more detailed and accurate hierarchical block split information is necessary, the information of the decoded image can be combined with the motion vector information to enhance accuracy of the split.

In addition, although description has been provided based on a CU size above, the same split can be performed even using information of a TU size. Furthermore, enhancement in detection accuracy can be achieved by using information of a CU size and a TU size.

In addition, since a PU size is split based on motion information of an image as described above with reference to FIG. 3, the boundary of regions with different motions can be estimated by viewing the PU size. For this reason, by performing the same image split using a PU size, an image can be split according to uniformity in the motions, and as a result, area split can be performed for each dynamic body and non-moving (still) object. In other words, in the case of a PU size, a dynamic body area is specified and information of a dynamic body area is generated.

The dynamic body area detector 122 performs specification of a dynamic body area and supplies information of the specified dynamic body area to the dynamic image processor 123 with single or combined split information of a frame using a CU, TU, or PU size described above.

The dynamic image processor 123 performs a high image quality process such as noise reduction, the frame number interpolation process, or the multi-frame super resolution process on the decoded image from the decoding section 111 using an in-screen correlation based on the information of the dynamic entity area from the dynamic body area detector 122 and the motion vector from the MV converter 121.

The dynamic image processor 123 outputs a high-quality image that is the result of the high image quality process to the outside.

[Configuration Example of a Decoding Section]

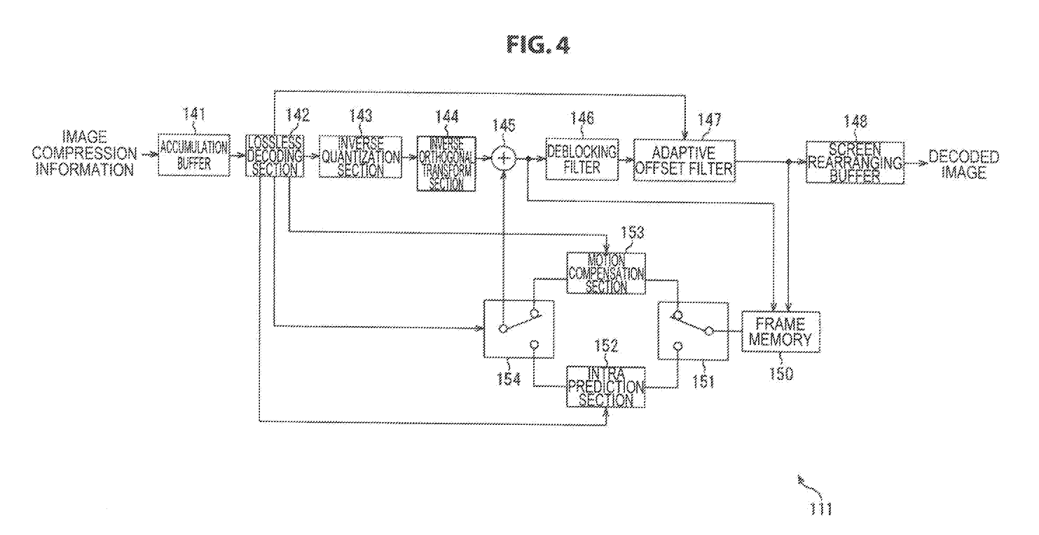

FIG. 4 is a block diagram showing a configuration example of the decoding section 111.

The decoding section 111 shown in FIG. 4 has an accumulation buffer 141, a lossless decoding section 142, an inverse quantization section 143, an inverse orthogonal transform section 144, a computing section 145, a deblocking filter 146, an adaptive offset filter 147, and a screen rearranging buffer 148. In addition, the decoding section 111 has a frame memory 150, a selecting section 151, an intra prediction section 152, a motion compensation section 153, and a predicted image selecting section 154.

The accumulation buffer 141 also serves as a receiving section which receives transmitted encoded data. The accumulation buffer 141 receives and accumulates transmitted encoded data, and supplies the encoded data to the lossless decoding section 142 at a predetermined timing. Information necessary for decoding such as quadtree information, prediction mode information, motion vector information, macroblock information, and an SAO parameter has been added to this encoded data.

The lossless decoding section 142 decodes information supplied from the accumulation buffer 141 and encoded on the encoding side which is not illustrated in a decoding scheme which corresponds to the encoding scheme. The lossless decoding section 142 supplies quantized coefficient data of a differential image obtained from the decoding to the inverse quantization section 143.

In addition, the lossless decoding section 142 determines whether an intra prediction mode has been selected or an inter prediction mode has been selected as an optimal prediction mode, and supplies information regarding the optimal prediction mode to one of the intra prediction section 152 and the motion compensation section 153 which corresponds to a mode that has been determined to be selected. In other words, for example, when the intra prediction mode is selected as the optimal prediction mode on the encoding side, the information regarding the optimal prediction mode is supplied to the intra prediction section 152. In addition, for example, when the inter prediction mode is selected as the optimal prediction mode on the encoding side, the information regarding the optimal prediction mode is supplied to the motion compensation section 153 along with the motion vector information.

Furthermore, the lossless decoding section 142 supplies information necessary for the high image quality process of the later stage, for example, the above-described quadtree information (hierarchical block split information), the prediction mode information, the motion vector information, the macroblock information, and a parameter used in sample adaptive offset (SAO; an adaptive offset filter) (which will be hereinafter referred to as an SAO parameter), and the like to the image processing section 112 of FIG. 2.

The inverse quantization section 143 inversely quantizes the quantized coefficient data obtained from decoding by the lossless decoding section 142 in a scheme corresponding to the quantization scheme of the quantization section of the encoding side. It should be noted that this inverse quantization section 143 is the same processing section as the inverse quantization section of the encoding side.

The inverse quantization section 143 supplies the obtained coefficient data to the inverse orthogonal transform section 144.

The inverse orthogonal transform section 144 performs an inverse orthogonal transform on the orthogonal transform coefficient supplied from the inverse quantization section 143 in the scheme corresponding to the orthogonal transform scheme of the orthogonal transform section of the encoding side if necessary. It should be noted that this inverse orthogonal transform section 144 is the same processing section as the inverse orthogonal transform section of the encoding side.

Image data of the differential image is restored through this inverse orthogonal transform process. The restored image data of the differential image corresponds to image data of the differential image before undergoing an orthogonal transform in an image encoding device. This restored image data of the differential image obtained from an inverse orthogonal transform process of the encoding side will also be referred to hereinafter as decoded residue data. The inverse orthogonal transform section 144 supplies this decoded residue data to the computing section 145. In addition, the computing section 145 receives supply of image data of a predicted image from the intra prediction section 152 or the motion compensation section 153 via the predicted image selecting section 154.

The computing section 145 obtains image data of a reconstructed image obtained by adding the differential image and the predicted image using the decoded residue data and the image data of the predicted image. This reconstructed image corresponds to the input image before the predicted image is subtracted therefrom by the encoding side. The computing section 145 supplies this reconstructed image to the deblocking filter 146.

The deblocking filter 146 removes block distortion by performing a deblocking filtering process on the supplied reconstructed image. The deblocking filter 146 supplies the image that has undergone the filtering process to the adaptive offset filter 147.

The adaptive offset filter 147 performs an adaptive offset filtering (sample adaptive offset or SAO) process for mainly removing ringing on the result of the deblocking filtering process (the decoded image of which block distortion has been removed) from the deblocking filter 146.

The adaptive offset filter 147 receives an offset value and information on the type of the adaptive offset filtering process (whether the process is in an edge offset mode or a band offset mode) for each largest coding unit (LCU) that is the largest encoding unit from the lossless decoding section 142. The adaptive offset filter 147 performs the adaptive offset filtering process of the received type on the image that has undergone the adaptive deblocking filtering process using the received offset value. Then, the adaptive offset filter 147 supplies the image that has undergone the adaptive offset filtering process (hereinafter referred to as a decoded image) to the screen rearranging buffer 148 and the frame memory 150.

It should be noted that the decoded image output from the computing section 145 can be supplied to the screen rearranging buffer 148 and the frame memory 150 without passing the deblocking filter 146 and the adaptive offset filter 147. That is to say, a part or all of the filtering process by the deblocking filter 146 can be omitted. In addition, an adaptive loop filter may be provided in the later stage of the adaptive offset filter 147.

The adaptive offset filter 147 supplies the decoded image which is the result of the filtering process (or the reconstructed image) to the screen rearranging buffer 148 and the frame memory 150.

The screen rearranging buffer 148 performs rearrangement of the order of frames of the decoded image. In other words, the screen rearranging buffer 148 rearranges images of the respective frames rearranged by the encoding side in an encoding order in the original display order. That is to say, the screen rearranging buffer 148 stores the image data of the decoded image of the respective frames supplied in the encoding order in that order, reads the image data of the decoded image of the respective frames stored in the encoding order, and outputs the image data to the image processing section 112 of FIG. 2.

The frame memory 150 stores the supplied decoded image, and supplies the stored decoded image as a reference image to the intra prediction section 152 and the motion compensation section 153 via the selecting section 151 at a predetermined timing or based on a request from the outside such as from the intra prediction section 152, the motion compensation section 153, and the like.

The intra prediction section 152 appropriately receives supply of intra prediction mode information and the like from the lossless decoding section 142. The intra prediction section 152 performs intra prediction in the intra prediction mode (an optimal intra prediction mode) used by the intra prediction section of the encoding side to generate a predicted image. At this time, the intra prediction section 152 performs the intra prediction using the image data of the reconstructed image supplied from the frame memory 150 via the selecting section 151. In other words, the intra prediction section 152 uses this reconstructed image as a reference image (peripheral pixels). The intra prediction section 152 supplies the generated predicted image to the predicted image selecting section 154.

The motion compensation section 153 appropriately receives supply of optimal prediction mode information, motion vector information, and the like from the lossless decoding section 142. The motion compensation section 153 performs inter prediction using the decoded image (reference image) acquired from the frame memory 150 in the inter prediction mode (optimal inter prediction mode) indicated by the optimal prediction mode information acquired from the lossless decoding section 142 to generate a predicted image.

The predicted image selecting section 154 supplies the predicted image supplied from the intra prediction section 152 or the predicted image supplied from the motion compensation section 153 to the computing section 145. Then, the computing section 145 obtains a reconstructed image obtained by adding the predicted image and the decoded residue data (differential image information) from the inverse orthogonal transform section 144.

[Example of Hierarchical Block Split Information]

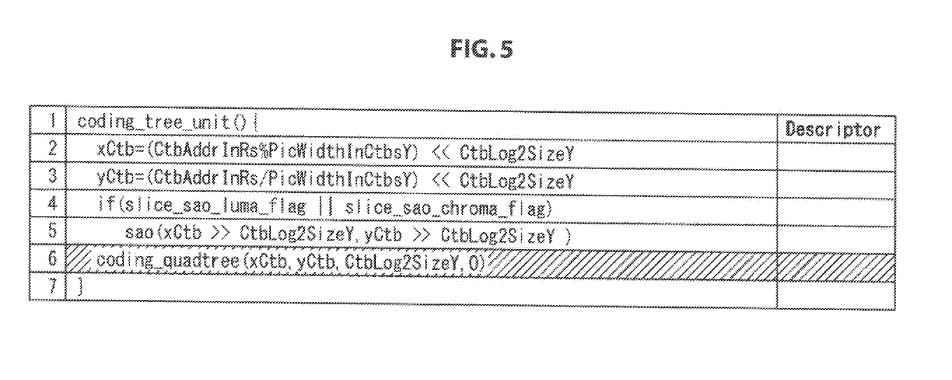

Next, a parsing method of a CU size as hierarchical block split information (quadtree information) will be described with reference to FIGS. 5 to 7. FIG. 5 is a diagram showing an example of syntax of a coding tree unit (CTU). It should be noted that the numbers at the left end of each row in the drawings showing syntax below are row numbers that are given for description.

In the 6^{th} row of FIG. 5, coding_quadtree is set for the syntax of the CTU.

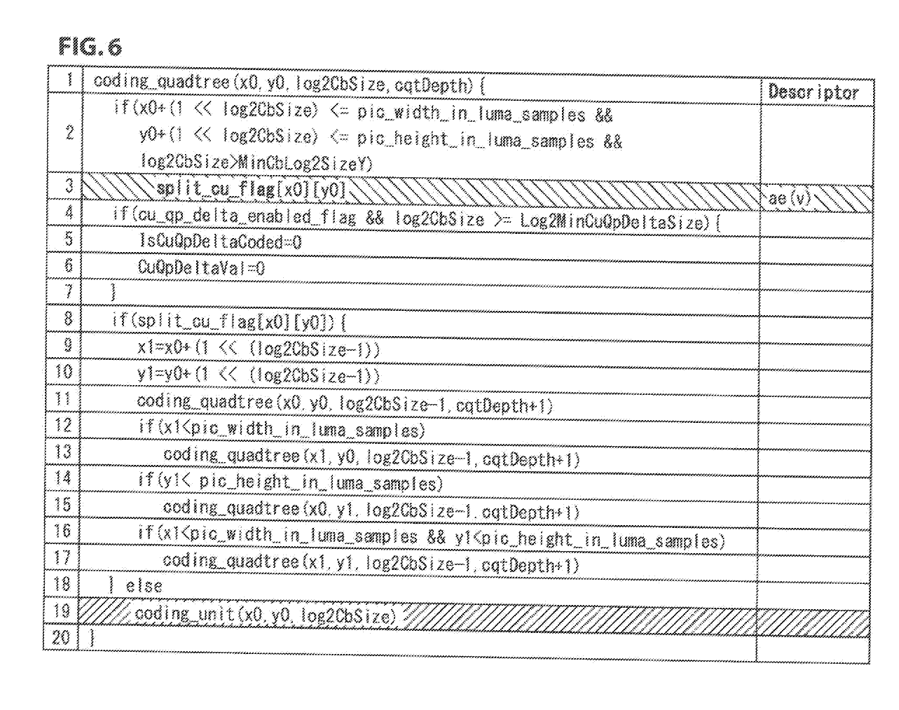

FIG. 6 is a diagram showing an example of syntax of coding_quadtree in the 6^{th} row of FIG. 5.

In the 3^{rd} row of FIG. 6, split_cu_flag is shown. Here, when split_cu_flag=1, it indicates that this CU is split into CUs of a smaller size.

As shown in the 8^{th} row to the 18^{th} row of FIG. 6, coding_quadtree is recursively called according to a split situation. In the 19^{th} row, coding_unit is set.

The CU size can be parsed by referring to split_cu_flag included in coding_quadtree of the CTU set as described above.

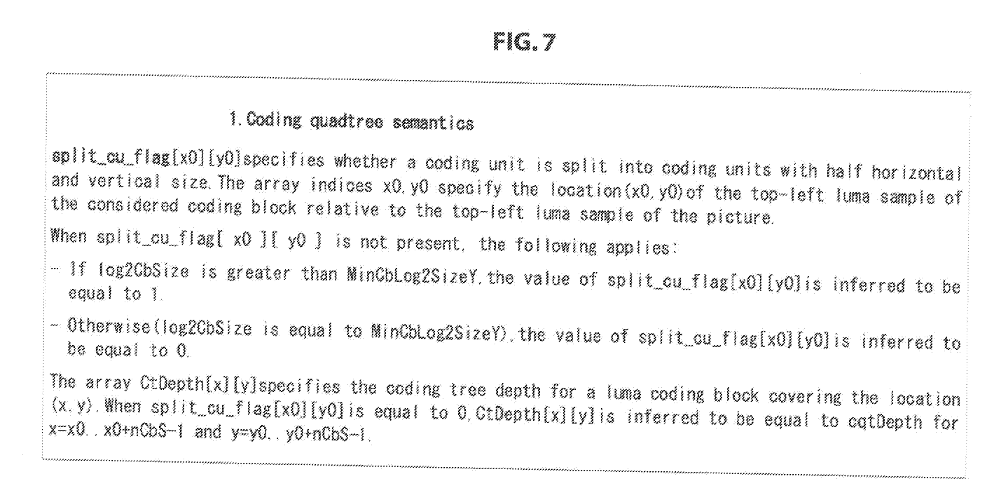

FIG. 7 is a diagram showing an example of semantics of split_cu_flag in the 3^{rd} row of FIG. 6.

split_cu_flag[x0][y0] indicates whether a cu has been split into cus of half the size thereof vertically and horizontally. The array index of x0 and y0 indicates the position of (x0), y0) of a luma pixel on the upper left side of a block regarded as relating to a luma pixel on the upper left side of an image.

When split_cu_flag[x0][y0] is not present, the following is applied.
If log 2CbSize is greater than MinCbLog 2SizeY, the value of split_cu_flag[x0][y0] is inferred to be equal to 1.
If this is not the case and log 2CbSize is equal to MinCbLog 2SizeY, the value of split_cu_flag[x0][y0] is inferred to be equal to 0.

The array of CtDepth[x][y] indicates depth of a coding tree of a luma block which covers the position of (x, y). When split_cu_flag[x0][y0] is equal to 0, CtDepth[x][y] is regarded as being equal to cqtDepth for x=x0 . . . x0+nCbS−1 and y=y0 . . . y0+nCbS 1.

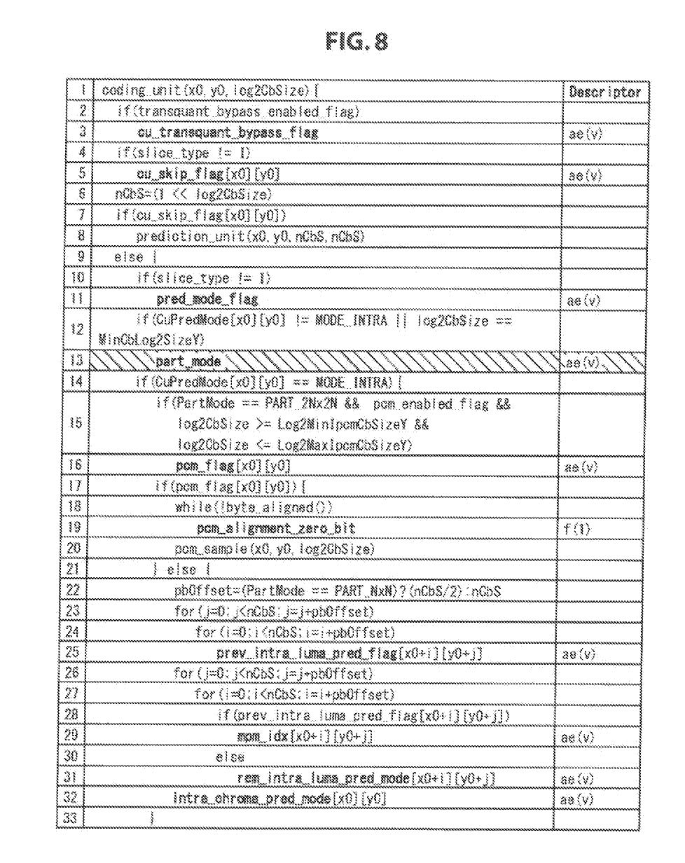

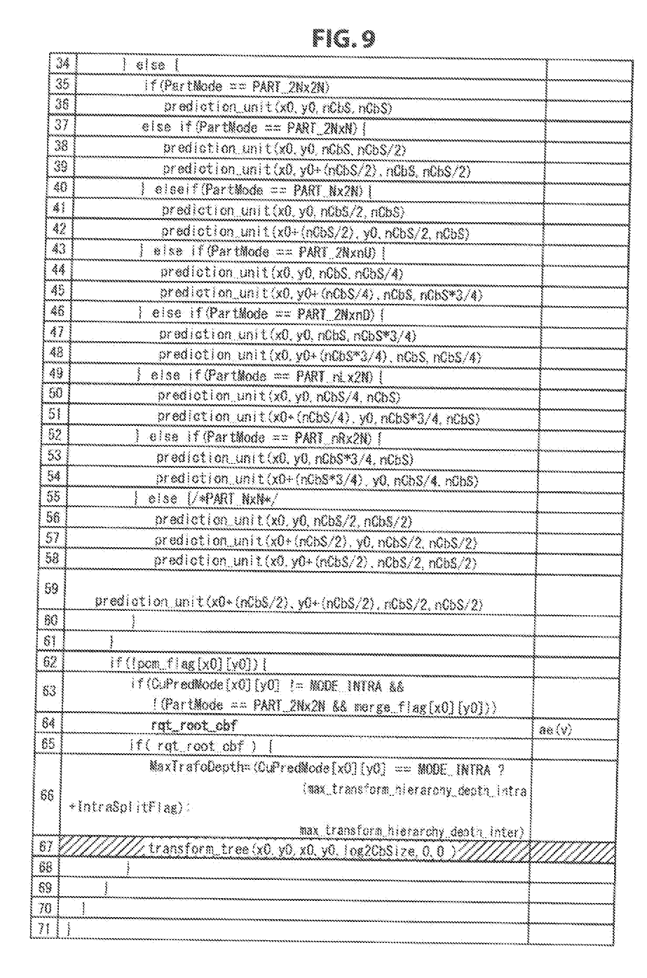

In addition, a parsing method of PU size as hierarchical block split information will be described with reference to FIGS. 8 to 10. FIGS. 8 and 9 are diagrams showing an example of syntax of the CIU (coding_unit) in the 19^{th} row of FIG. 6 described above.

In the 13^{th} row of FIG. 8, part_mode is set. In addition, in the 67^{th} row of FIG. 9, transform_tree is set.

Here, the PU size can be parsed by referring to part_mode to be described next in coding_unit included in coding_quadtree of the CTU set as described above.

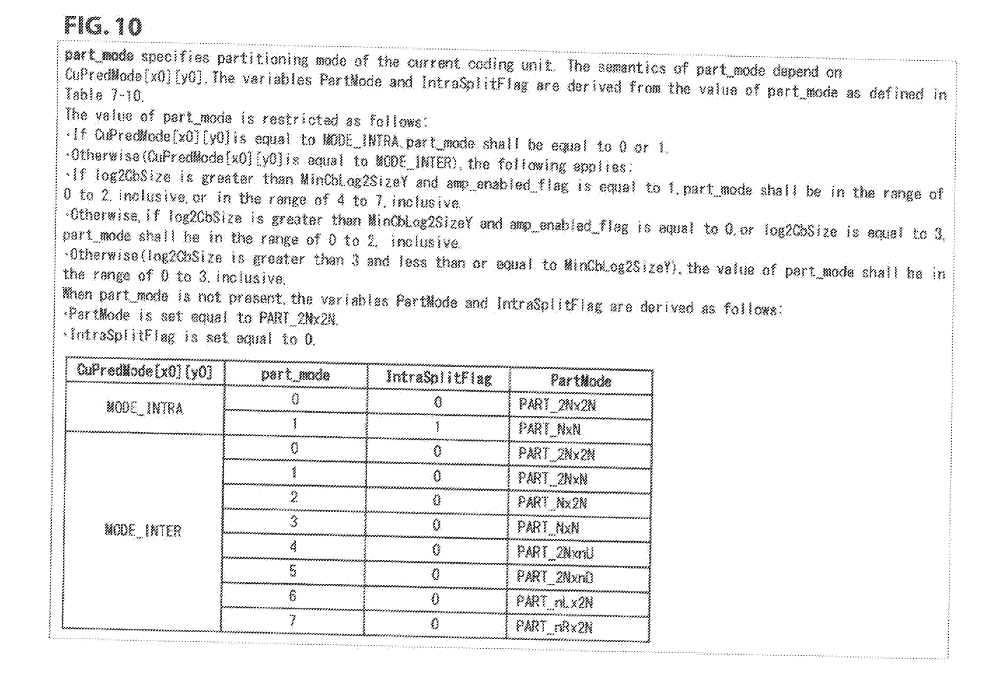

FIG. 10 is a diagram showing an example of semantics of part_mode of the 13^{th} row of FIG. 8.

The semantics of part_mode indicates the partitioning mode of the current CU. The semantics of part_mode depends on CuPredMode[x0][y0]. PartMode and IntraSplitFlag are variously elicited from the values of part_mode defined in the table in the lower part of the drawing.

The values of part_mode are restricted as follows.
If CuPredMode[x0][y0] is equal to Mode_INTRA, part_mode is equal to 0 or 1.
If this is not the case, and CuPredMode[x0][y0] is equal to Mode_IINTER, the following is applied.
If log 2CbSize is greater than MinCbLog 2SizeY and amp_enabled flag is equal to 1, part_mode is included in the range from 0 to 2 or the range from 4 to 7.
If this is not the case, and log 2CbSize is greater than MinCbLog 2SizeY and amp_enabled_flag is equal to 1 or log 2CbSize is equal to 3, part_mode is included in the range from 0 to 2.
If this is not the case, and log 2CbSize is greater than 3 and equal to or smaller than MinCbLog 2SizeY, the value of part_mode is included in the range from 0 to 3.

When part_mode is not present, PartMode and IntraSplitFlag are variously elicited as follows.
PartMode is set to PART_2N×2N.
IntraSplitFlag is set to 0.

The table shown in FIG. 10 shows the following. In other words, it is shown that, when CuPredMode[x0][y0] is Mode_INTRA, part_mode is 0 and IntraSplitFlag is 0, PartMode is PART 2N×2N. It is shown that, when CuPredMode[x0][y0] is Mode_INTRA, part_mode is 1 and IntraSplitFlag is 1, PartMode is PART N×N.

It is shown that, when CuPredMode[x0][y0] is Mode_INTER, part_mode is 0, and IntraSplitFlag is 0, PartMode is PART 2N×2N. It is shown that, when CuPredMode[x0][y0] is Mode_INTER, part_mode is 1, and IntraSplitFlag is 0, PartMode is PART 2N×N.

It is shown that, when CuPredMode[x0][y0] is Mode_INTER, part_mode is 2, and IntraSplitFlag is 0, PartMode is PART N×2N. It is shown that, when CuPredMode[x0][y0] is Mode_INTER, part_mode is 3, and IntraSplitFlag is 0, PartMode is PART N×N.

It is shown that, when CuPredMode[x0][y0] is Mode_INTER, part_mode is 4, and IntraSplitFlag is 0. PartMode is PART 2N×nU. It is shown that, when CuPredMode[x0][y0] is Mode_INTER, part_mode is 5, and IntraSplitFlag is 0, PartMode is PART 2N×nD.

It is shown that, when CuPredMode[x0][y0] is Mode_INTER, part_mode is 6, and IntraSplitFlag is 0, PartMode is PART nL×2N, It is shown that, when CuPredMode[x0][y0] is Mode_INTER, part_mode is 7, and IntraSplitFlag is 0, PartMode is PART nR×2N.

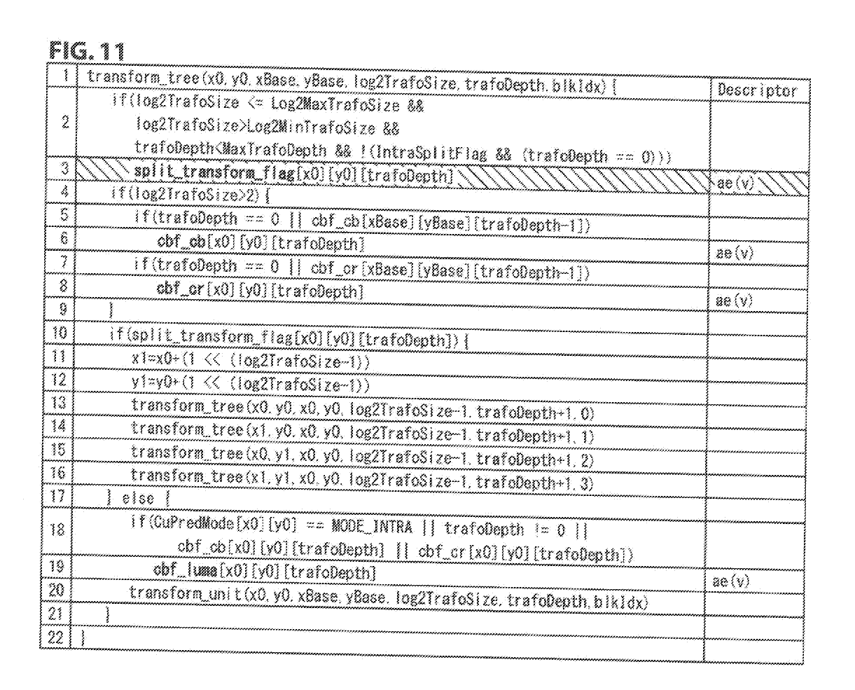

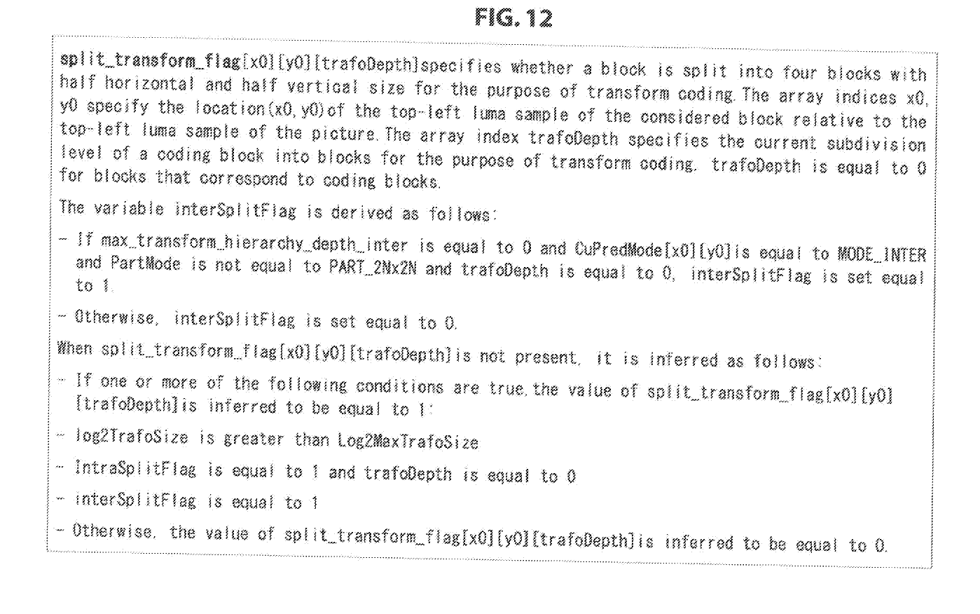

Further, a parsing method with a TU size as hierarchical block split information will be described with reference to FIGS. 11 and 12. FIG. 11 is a diagram showing an example of syntax of transform_tree in the 67^{th} row of FIG. 9 described above.

In the 3^{rd} row of FIG. 11, split_transform_flag is set. As shown in the 13^{th} row to the 16^{th} row of FIG. 11, transform_tree is configured to be recursively called.

Here, the TU size can be parsed by referring to split_transform_flag to be described next of transform_tree of coding_unit included in coding_quadtree of the CTU set as described above.

FIG. 12 is a diagram showing an example of semantics of split_transform_flag in the 3^{rd} row of FIG. 11.

split_transform_flag[x0][y0][trafoDepth] indicates whether one block has been split into 4 blocks of half the size thereof vertically and horizontally for transform coding. The array index of x0 and y0 indicates the position of (x0, y0) of a luma pixel on the upper left side of a block regarded as relating to a luma pixel on the upper left side of an image. The array index of trafoDepth indicates the current split level of a coding block into blocks for the purpose of transform coding. trafoDepth is equal to 0 because it is a block which coincides with the coding block.

interSlritFlag is variously elicited as follows.
If maxtransform_hierarchy_depth_inter is equal to 0, CuPredMode[x0][y0] is MODE_INTER. PartMode is not PART_2N×2N, and trafoDepth is equal to 0, interSplitFlag is set to be equal to 1.
Otherwise, interSplitFlag is set to be equal to 0.

When split_transform_flag[x0][y0][trafoDepth] is not present, the following is elicited.
If one or more of the following conditions is true, split_transform_flag[x0][y0][trafoDepth] is inferred to be equal to 1.
Log 2TrafoSize is greater than Log 2MaxTrafoSize.
IntraSplitFlag is equal to 1, and trafoDepth is equal to 0.
IntraSplitFlag is equal to 1.
Otherwise, the value of split_transform_flag[x0][y0][trafoDepth] is equal to 0.

[Configuration of a Dynamic Body Area Detector]

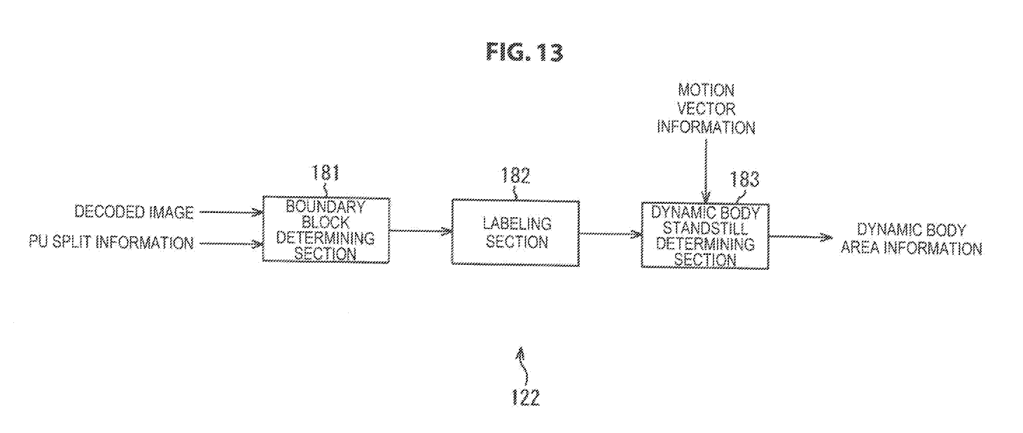

FIG. 13 is a block diagram showing a configuration example of the dynamic body area detector of FIG. 2. The example of FIG. 13 shows that PU split information is input as hierarchical block split information.

The dynamic body area detector 122 is configured to include a boundary block determining section 181, a labeling section 182, and a dynamic body standstill determining section 183.

The boundary block determining section 181 receives an input decoded image from the decoding section 111 and PU split information as hierarchical block split information.

The boundary block determining section 181 creates a block size map using the PU split information, and determines boundary blocks referring to the created map. In other words, the boundary block determining section 181 sets a boundary initial value, determines convergence of an object boundary, and updates object boundary information as determination of the boundary blocks. In addition, the boundary block determining section 181 specifies blocks which are on or close to a boundary as boundary (edge) blocks based on the object boundary information.

The boundary block determining section 181 supplies the decoded image, the created block size map, and information of the specified boundary blocks to the labeling section 182.

The labeling section 182 integrates blocks close to each other in the image based on the boundary blocks specified by the boundary block determining section 181, performs labeling in units of objects, and splits the blocks into areas in units of objects. The labeling section 182 outputs the decoded image and information on the area of each object to the dynamic body standstill determining section 183.

In addition, the dynamic body standstill determining section 183 receives input of motion vector information from the MV converter 121.

The dynamic body standstill determining section 183 calculates the average value of motion vectors for the area of each object, and determines the area to be a dynamic body area or a standstill area according to whether the calculated average value of the motion vectors is equal to or greater than a threshold value. The result of the determination by the dynamic body standstill determining section 183 is supplied to the dynamic image processor 123 as dynamic body area information.

[Detection of a Boundary Line of an Object]

As described above, in the dynamic body area detector 122, an area split method typified by SNAKE is applied and then labeling is performed in units of objects. Here, a method for detecting a boundary line of an object from information of the block size map generated based on the hierarchical block split information will be described.

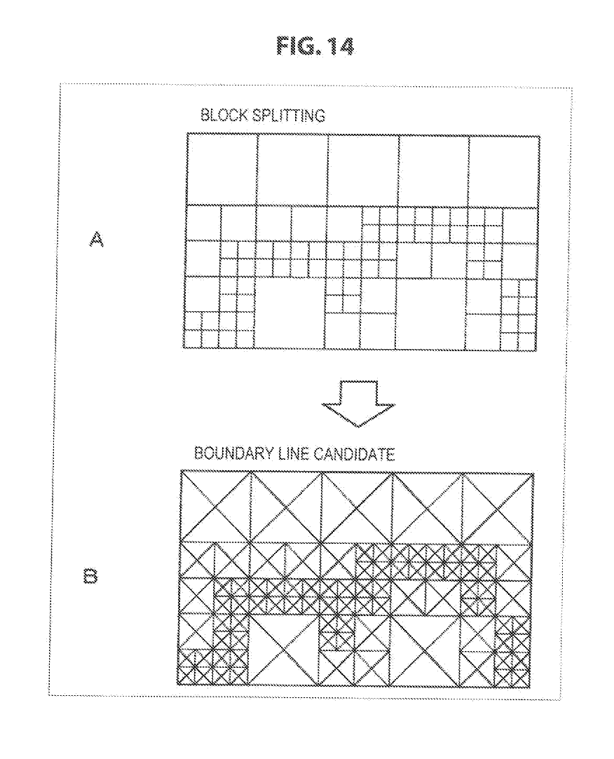

First, a boundary line is selected from edges and diagonal lines of each block split in block splitting. In block splitting shown in A of FIG. 14, candidates for boundary lines are the group of smallest rectangles shown in B of FIG. 14.

Here, costs are calculated according to a pre-decided energy (cost) calculation method, and a boundary line on which energy is the smallest is obtained to be used in subsequent processes.

For example, as shown in the following expression (1), an edge boundary is assumed to be obtained by setting energy of the edge boundary and obtaining a condition for the boundary on which energy is minimum.

[Math 1]

E=Eᵢₙₜ+Eₑₓₜ (1)

Eᵢₙₜ is defined as internal energy, and generally, the length of boundary lines or the like is applied thereto. As Eᵢₙₜ, for example, the total of distances of boundary lines or the like is used.

In addition, Eₑₓₜ is defined as external energy, and for example, great energy is assigned to a boundary line which is close to or passes by a large block and small energy is assigned to a boundary line which is close to a small block.

As described above, by defining energy and obtaining a boundary line on which energy is minimum, a boundary line which passes by a small block and does not follow a useless path can be computed.

It should be noted that, by also using information of the decoded image, a split boundary can be enhanced to pixel accuracy.

### [Image Process]

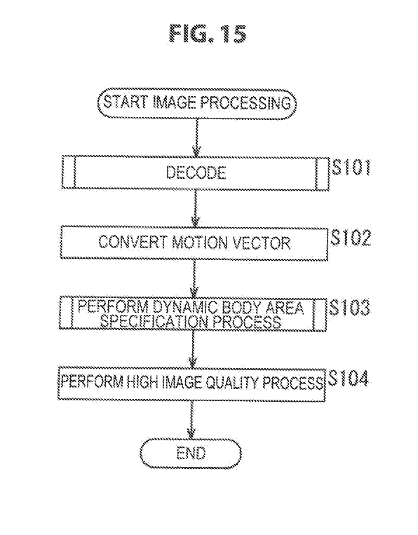

Next, image processing by the image processing device 101 of FIG. 2 will be described with reference to the flowchart of FIG. 15.

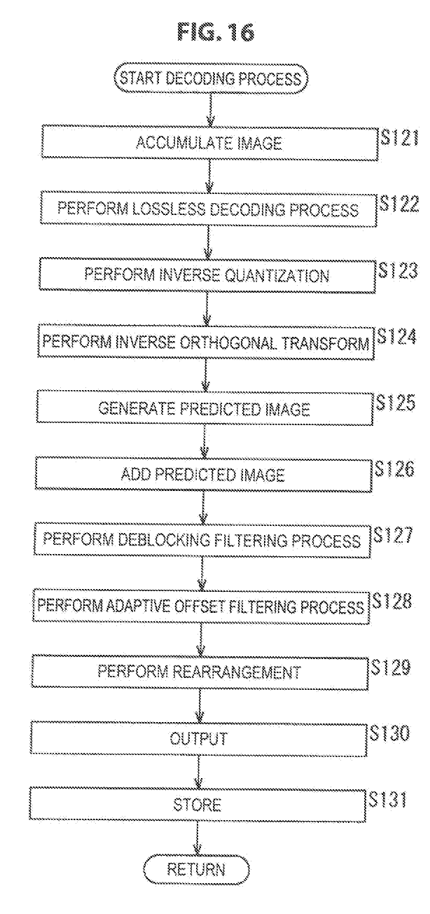

The decoding section 111 receives input of bit streams encoded by an external device which is not illustrated according to the HEVC standard. The decoding section 111 decodes the input bit streams according to the HEVC standard in Step S101. This decoding process will be described below with reference to FIG. 16. The decoding section 111 outputs the decoded image which has been decoded in Step S101 to the dynamic body area detector 122 and the dynamic image processor 123.

In addition, the decoding section 111 outputs motion vector information which is encoded information included in the bit streams used in the decoding to the MV converter 121. The decoding section 111 outputs hierarchical block split information of a PU which is encoded information included in the bit streams used in the decoding to the dynamic body area detector 122.

In Step S102, the MV converter 121 performs normalization in the direction from the encoding order to the display order or the like based on the motion vector information from the decoding section 111, performs signal processing, and thereby converts the information into a motion vector that is available for respective sections in the later stage. The MV converter 121 supplies the converted motion vector to the dynamic body area detector 122 and the dynamic image processor 123.

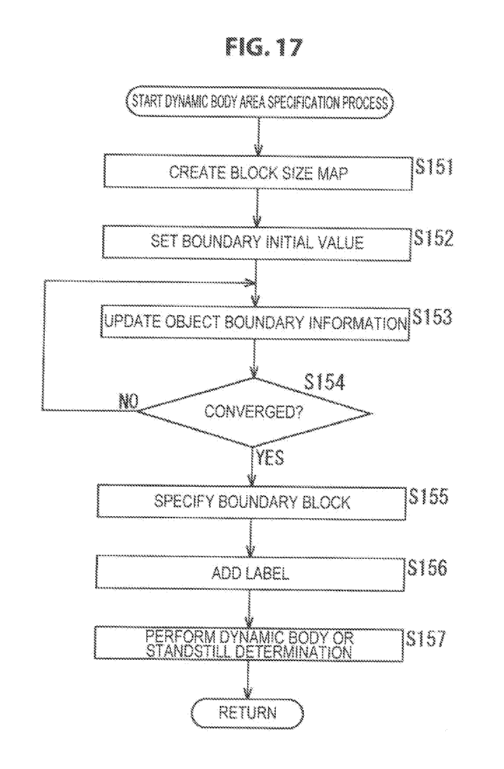

In Step S103, the dynamic body area detector 122 performs a dynamic body area specification process using the hierarchical block split information, the motion vector, the information of the decoded image, and the like. This dynamic body area characteristic process will be described below with reference to FIG. 17.

A dynamic body area is specified in Step S103, and information of the specified dynamic body area is supplied to the dynamic image processor 123.

In Step S104, the dynamic image processor 123 performs the high image quality process such as the frame number interpolation process (high frame-rate process) or noise reduction on the decoded image from the decoding section 111 based on the information of the dynamic entity area from the dynamic body area detector 122 and the motion vector from the MV converter 121. The dynamic image processor 123 outputs a high-quality image which is the result of the high image quality process to the outside.

[Flow of a Decoding Process]

Next, an example of the flow of the decoding process executed by the decoding section 111 in Step S101 of FIG. 15 will be described with reference to FIG. 16.

When the decoding process is started, the accumulation buffer 141 accumulates the transmitted bit streams (encoded data) in Step S121. In Step S122, the lossless decoding section 142 decodes the bit streams (encoded data) supplied from the accumulation buffer 141. In other words, image data such as I-pictures, P-pictures, B-pictures, and the like encoded on the encoding side is decoded.

At this time, various kinds of information other than the image data included in the bit streams such as header information are also decoded. Then, the lossless decoding section 142 supplies necessary information among the various kinds of decoded information to each corresponding section. In addition, the lossless decoding section 142 supplies information among the various kinds of decoded information necessary for the high image quality process in the later stage, for example, the above-described hierarchical block split information, prediction mode information, motion vector information, macroblock information, SAO parameter, and the like to the image processing section 112 of FIG. 2.

In Step S123, the inverse quantization section 143 inversely quantizes a quantized coefficient obtained from the process of Step S122. In Step S124, the inverse orthogonal transform section 144 performs an inverse orthogonal transform on the coefficient inversely quantized in Step S123.

In Step S125, the intra prediction section 152 or the motion compensation section 153 performs the prediction process and generates a predicted image. In other words, the prediction process is performed in the prediction mode that is determined to have been applied at the time of encoding by the lossless decoding section 142. More specifically, for example, when the intra prediction is applied at the time of encoding, the intra prediction section 152 generates the predicted image in the intra prediction mode recognized to be optimal at the time of encoding. Further, for example, when the inter prediction is applied at the time of encoding, the motion compensation section 153 generates the predicted image in the inter prediction mode recognized to be optimal at the time of encoding.

In Step S126, the computing section 145 adds the predicted image generated in Step S125 to a differential image obtained through the inverse orthogonal transform in Step S124. Accordingly, image data of a reconstructed image is obtained.

In Step S127, the deblocking filter 146 performs a deblocking filtering process on the image data of the reconstructed image obtained from the process of Step S126. Accordingly, block distortion or the like is removed. In Step S128, the adaptive offset filter 147 performs an adaptive offset filtering process for mainly removing ringing on the result of the deblocking filtering process supplied from the deblocking filter 146. At this time, the SAO parameter from the lossless decoding section 142 is used.

In Step S129, the screen rearranging buffer 148 performs rearrangement of respective frames of the reconstructed image that has undergone the adaptive offset filtering process in Step S128. In other words, the frames rearranged at the time of encoding are rearranged in the original display order.

In Step S130, the screen rearranging buffer 148 outputs decoded images of the respective frames to the image processing section 112 of FIG. 2.

In Step S131, the frame memory 150 stores data of the decoded image obtained from the process of Step S128, the reconstructed image obtained from the process of Step S127, and the like.

When the process of Step S131 ends, the decoding process ends, and the process returns to the process of FIG. 15.

[Dynamic Body Area Specification Process]

Next, the dynamic body area characteristic process of Step S103 of FIG. 15 will be described with reference to the flowchart of FIG. 17 and FIGS. 18 and 19.

The boundary block determining section 181 receives input of the decoded image from the decoding section 111 and PU split information as hierarchical block split information.

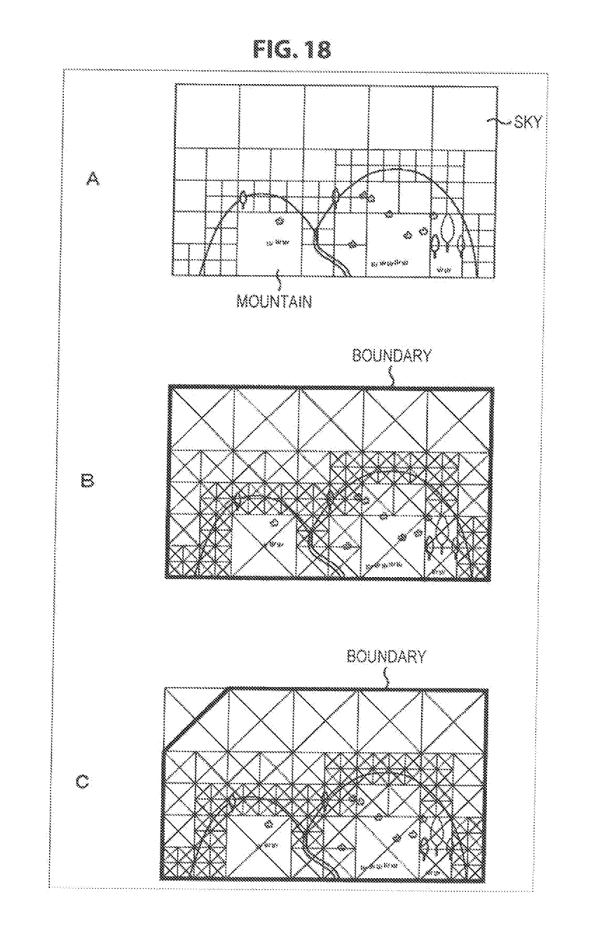

In Step S151, the boundary block determining section 181 creates a block size map using the PU split information. For example, as shown in A of FIG. 18, there is a tendency for large blocks (for example, PUs) to be assigned to areas having uniform feature amounts such as the sky and mountains and small blocks to be assigned to local areas having significant changes in feature amounts such as ridges of mountains.

Using this property of HEVC streams, the boundary block determining section 181 creates a block size map which indicates which position located in an image has been split from the PU split information. Accordingly, states of blocks which are spatially close to each other and thus hard to recognize in the PU split information can be easily recognized.

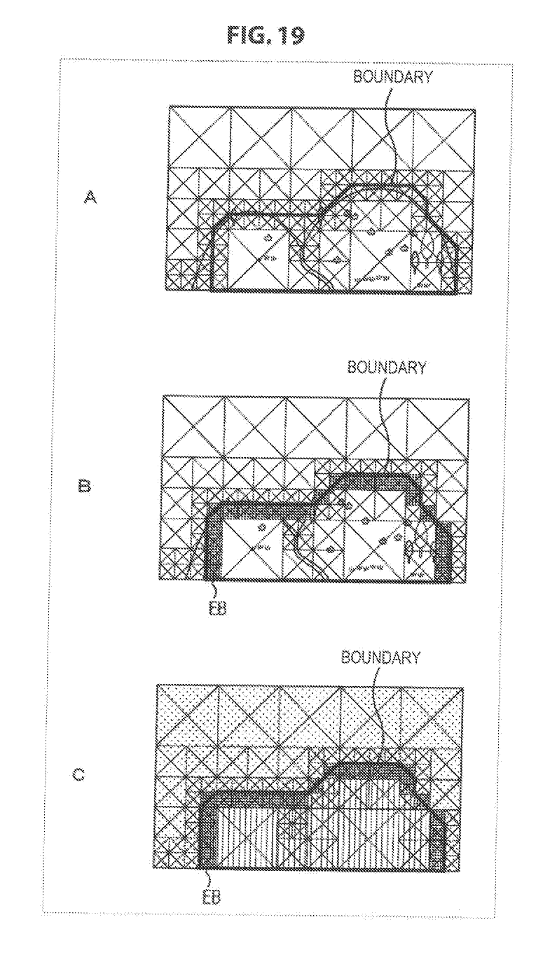

In Step S152, the boundary block determining section 181 sets a boundary initial value. For example, the picture frame is set as a boundary as shown in B of FIG. 18. Note that the examples of FIGS. 18 and 19 show the boundaries set with thick lines.

In Step S153, the boundary block determining section 181 performs updating of the object boundary information. In other words, as updating of the object boundary information, the boundary block determining section 181 performs a process of causing the object boundary to converge to update the object boundary information.

Specifically, the boundary block determining section 181 changes only one spot of the boundary initial value set in Step S152 as indicated by the thick line on the upper left part of C of FIG. 18 to compute a boundary line with lower energy. When there are a plurality of changeable spots, a spot (boundary) on which a decline of energy is the largest is changed.

In Step S154, the boundary block determining section 181 determines whether or not the boundary has converged. When there is still a candidate for a boundary line to be changed and it is determined that the boundary has not converged in Step S154, the process returns to Step S153, and the process and succeeding ones are repeated.

For example, when there is no candidate for a boundary line to be changed as shown in A of FIG. 19 and it is determined that the boundary has converged in Step S154, the process proceeds to Step S155.

In Step S155, the boundary block determining section 181 specifies blocks which are present on or close to the boundary line indicated by the thick line in B of FIG. 19 as boundary blocks EB based on the object boundary information updated in Step S153.

The boundary block determining section 181 supplies the decoded image, the created block size map, and information of the specified boundary blocks EB to the labeling section 182.

In Step S156, the labeling section 182 integrates blocks close to each other in the image based on the boundary blocks EB specified by the boundary block determining section 181, and adds labels thereto in units of objects. In other words, as shown by the different types of hatching in C of FIG. 19, labels are added to areas of each object. The labeling section 182 outputs the decoded image and information of the areas of each object to the dynamic body standstill determining section 183.

In Step S157, the dynamic body standstill determining section 183 performs determination of a dynamic body and standstill. In other words, the dynamic body standstill determining section 183 computes the average value of motion vectors for each area of the object, and determines the area to be a dynamic body area or a standstill area according to whether the computed average value of the motion vectors is equal to or higher than a threshold value. The result of determination by the dynamic body standstill determining section 183 is supplied to the dynamic image processor 123 as dynamic body area information.

Note that, when there are a plurality of objects, the plurality of objects can also be split by setting different initial values and performing an arithmetic operation of convergence.

Since the dynamic body area information is generated using the encoded information that has been decoded and is set to be used in the high image quality process, the high image quality process can be performed with good efficiency at low costs. In addition, detection of areas and the high image quality process can be performed to a high degree of accuracy.

Furthermore, robustness against compression noise can be realized. In other words, general compression distortion such as block noise often has an adverse effect on determination of an area of an object or the like. In order to deal with this, by using bit stream information (encoded information that has been decoded) without using image information directly, such an effect of compression distortion on images can be suppressed.

Note that, although the example in which hierarchical block split information and motion vector information are used as such encoded information that has been decoded has been described above, other parameters can also be used. Next, an example in which a macroblock type and an SAO parameter are used as an example of another parameter will be described.

### Second Embodiment

### Overview

First, an occlusion area and detection of a deformed object using information regarding SAO will be described.

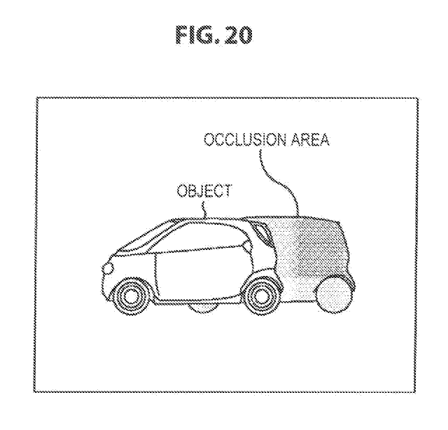

There are cases in which, in image processing such as the frame number interpolation process, a process of detecting an occlusion area which appears due to a movement of an object as shown in FIG. 20, an excessively deformed object, or the like, restricting reference to near frames, or the like is necessary.

In image encoding, encoding using intra macroblocks with respect to blocks for which motion prediction is not effectively used is often performed. In other words, for a background part after an object moves (i.e., an occlusion area) or an excessively deformed object, or immediately after a scene change, intra macroblocks are often selected and encoded in in-image prediction.

Thus, by using a macroblock type which is the encoded information that has been decoded, an occlusion area and an excessively deformed area can be detected.

There are cases, however, in which an intra macroblock is selected in a flat background area which includes no edge, rather than an occlusion and an excessively deformed area. When noise overlaps a flat part such as a white wall during photographing in a dark place, intra-frame prediction is determined to be more advantageous in encoding efficiency than inter-frame prediction due to influence of the noise, and thereby intra prediction may be used.

As described above, an occlusion and an excessively deformed area can be detected by focusing on intra macroblocks (information of macroblocks); however, it is necessary to exclude a selected flat pan in view of encoding efficiency.

Therefore, in the present technology, an occlusion and an excessively deformed area can be detected by using an SAO parameter used in SAO of the adaptive offset filter 147 shown in FIG. 4 described above, in addition to information of a macroblock type which is the encoded information that has been decoded.

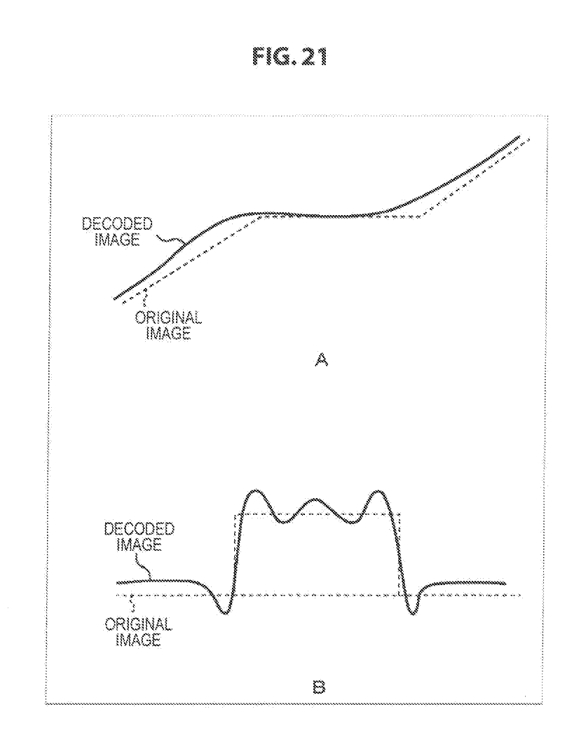

SAO is used to suppress an error of a DC component occurring in a decoded image and distortion such as mosquito noise in the periphery of edges. There are two types of SAO including band offset and edge offset. Band offset is used to correct an error of a DC current on a decoded image as shown in A of FIG. 21. On the other hand, edge offset is used to correct mosquito noise occurring in the periphery of edges as shown in B of FIG. 21.

Since mosquito noise occurs in the periphery of edges, edge offset is mostly selected near edges. Conversely, since edge offset is rarely selected in flat parts, an edge part and a flat part can be classified using an SAO mode which indicates whether it is an edge offset mode or a band offset mode.

By ascertaining both the macroblock mode and the SAO modes using these characteristics, an occlusion area and an excessively deformed area can be detected.

In other words, the flag of a macroblock type and the flag of an SAO mode are acquired from bit streams, and it can be inferred that a macroblock whose macroblock type is intra and for which the edge offset mode has been selected is an occlusion area or an excessively deformed area.

For this reason, there is a possibility of such an area not being suitable for a time axis process such as the frame number interpolation process (high frame-rate process). Thus, the area can be set as a processing-free area of the time axis process by using the above information. Accordingly, image failure caused by the time axis process can be prevented.

[Configuration Example of an Image Processing Device]

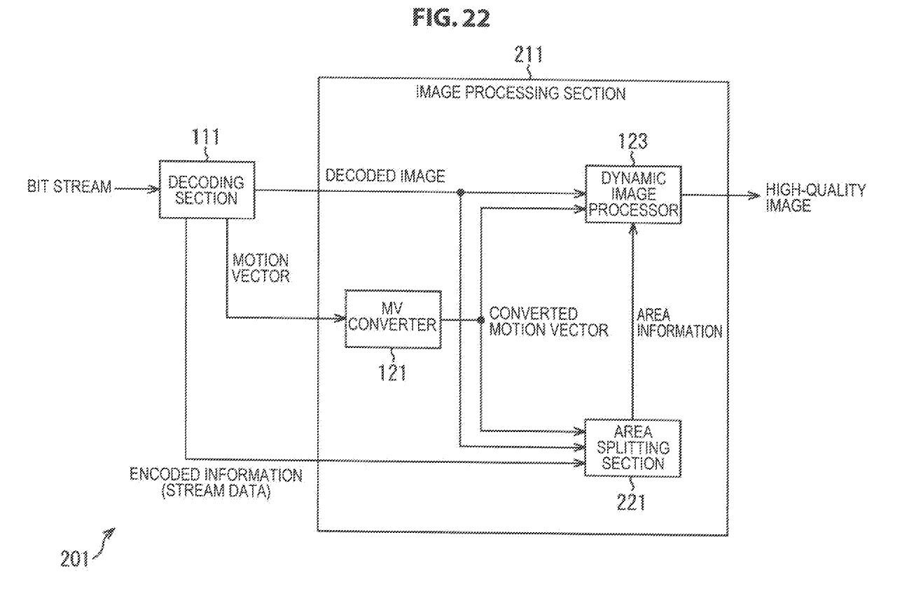

FIG. 22 is a block diagram showing another configuration example of the image processing device which uses encoded information. In the example of FIG. 22, the image processing device 201 includes the decoding section 111 and an image processing section 211.

To be specific, the image processing device 201 is the same as the image processing device 101 of FIG. 2 in that they have the decoding section 111. On the other hand, the image processing device 201 is different from the image processing device 101 of FIG. 2 in that the image processing section 112 is replaced with the image processing section 211.

The image processing section 211 is the same as the image processing section 112 of FIG. 2 in that the MV converter 121 and the dynamic image processor 123 are included. The image processing section 211 is different from the image processing section 112 of FIG. 2 in that the dynamic body area detector 122 is replaced with an area splitting section 221.

That is, a decoded image from the decoding section 111 is input to the area splitting section 221 and the dynamic image processor 123. The encoded information that has been decoded (stream data) from the decoding section 111 is input to the area splitting section 221. For the encoded information, for example, hierarchical block split information, a macroblock type, an SAO mode, or the like is exemplified. A converted motion vector from the MV converter 121 is supplied to the area splitting section 221 and the dynamic image processor 123.

The area splitting section 221 decides a time axis processing area using the encoded information from the decoding section 111 (hierarchical block split information, macroblock type, SAO mode, or the like), information of the motion vector from the MV converter 121, and information of the decoded image. The area splitting section 221 supplies information of the decided area to the dynamic image processor 123.

Note that, when only an occlusion area and an excessively deformed area are detected, the area splitting section 221 may have a macroblock type and an SAO mode as the encoded information, and in this case, the hierarchical block information and the motion vector are not necessary.

[Configuration Example of an Area Splitting Section]

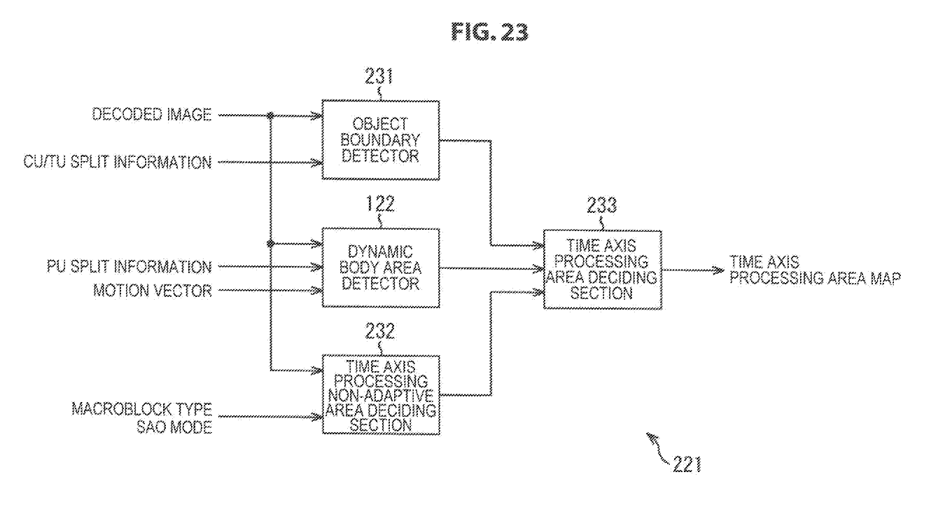

FIG. 23 is a block diagram showing a detailed configuration example of the area splitting section of FIG. 22.

In the example of FIG. 23, the area splitting section 221 is configured to include an object boundary detector 231, the dynamic body area detector 122 of FIG. 2, a time axis processing non-adaptive area deciding section 232, and a time axis processing area deciding section 233.

A decoded image from the decoding section 111 is input to the object boundary detector 231, the dynamic body area detector 122, and the time axis processing non-adaptive area deciding section 232. In addition, CU/TU split information included in encoded information from the decoding section 111, is input to the object boundary detector 231. PU split information included in the encoded information from the decoding section 111 is input to the dynamic body area detector 122. Information of a macroblock type and an SAO mode included in the encoded information from the decoding section 111 is supplied to the time axis processing non-adaptive area deciding section 232.

The object boundary detector 231 detects object boundary information based on the decoded image and the CU/TU split information. The object boundary detector 231 supplies the detected object boundary information to the time axis processing area deciding section 233.

The dynamic body area detector 122 is configured basically identically to the dynamic body area detector 122 of FIG. 2. The dynamic body area detector 122 detects the boundary of an object based on the decoded image, the PU split information, and the motion vector information, performs determination of motion or standstill for each area after splitting for each area, and then detects a dynamic body area. Information of the dynamic body area detected by the dynamic body area detector 122 is supplied to the time axis processing area deciding section 233.

The time axis processing non-adaptive area deciding section 232 executes detection of an area such as an occlusion or an excessively deformed object to which the time axis process is not applicable based on the decoded image, macroblock type, and SAO mode. Information decoded by the time axis processing non-adaptive area deciding section 232 is supplied to the time axis processing area deciding section 233.

The time axis processing area deciding section 233 generates a final area map with respect to the time axis process based on the object boundary information, the dynamic body area, and the time axis processing non-adaptive area, and supplies information of the generated area map to the dynamic image processor 123 of FIG. 22.

Note that the example of FIG. 23 shows that the macroblock type, the SAO mode, and the hierarchical block split information are used together. Thus, when only a macroblock type and an SAO mode are used, the object boundary detector 231 and the dynamic body area detector 122 may be removed from the area splitting section 221.

[Configuration Example of an Object Boundary Detector]

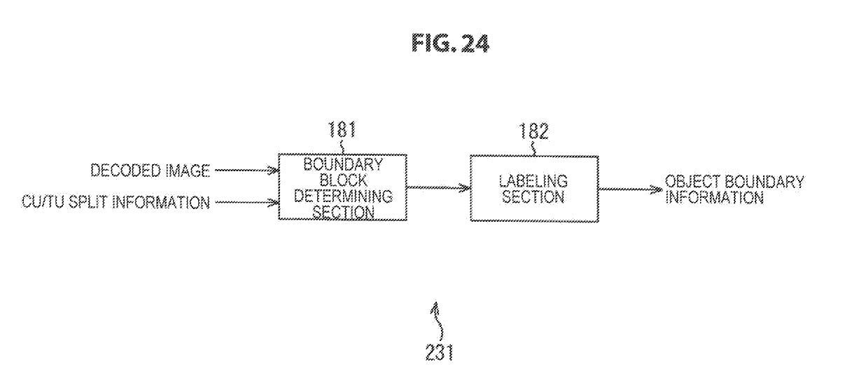

FIG. 24 is a block diagram showing a configuration example of the object boundary detector 231 of FIG. 23. The example of FIG. 24 shows that CU/TU split information is input as hierarchical block split information.

In the example of FIG. 24, the object boundary detector 231 is the same as the dynamic body area detector 122 of FIG. 13 in that they have the boundary block determining section 181 and the labeling section 182. The object boundary detector 231 is different from the dynamic body area detector 122 of FIG. 13 in that the dynamic body standstill determining section 183 has been removed, and the hierarchical block split information input to the boundary block determining section 181 is CU/TU split information rather than PU split information.

That is, the boundary block determining section 181 creates a block size map using the CU/TU split information, and determines boundary blocks referring to the created map. That is, the boundary block determining section 181 sets a boundary initial value, determines convergence of the boundary of an object, and updated object boundary information as determination of boundary blocks. Then, the boundary block determining section 181 specifies blocks which are on or close to the boundary as boundary (edge) blocks based on the object boundary information.

The boundary block determining section 181 supplies the decoded image, the created block size map, and information of the specified boundary blocks to the labeling section 182.

The labeling section 182 integrates blocks close to each other in an image based on the boundary blocks specified by the boundary block determining section 181, performs labeling in units of objects, and splits the blocks into areas in units of objects. The labeling section 182 supplies the decoded image and information on the areas of the respective objects to the time axis processing area deciding section 233.

[Image Processing]

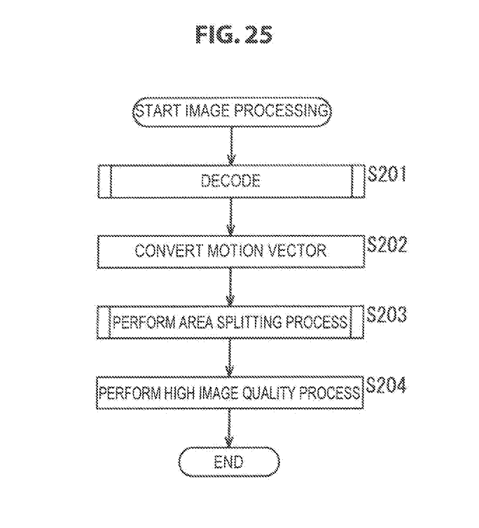

Next, image processing by the image processing device 201 of FIG. 22 will be described with reference to FIG. 25.

The decoding section 111 receives input of bit streams encoded by an external section which is not illustrated according to the HEVC standard. The decoding section 11 decodes the input bit stream according to the HEVC standard in Step S201. Since this decoding process is repetitive because it is basically the same as the process described above with reference to FIG. 16, description thereof will be omitted. The decoding section 111 outputs the image decoded in Step S201 to the area splitting section 221 and the dynamic image processor 123.

In addition, the decoding section 111 outputs motion vector information which is encoded information included in the bit streams used in the decoding to the MV converter 121. The decoding section 11 outputs the encoded information (hierarchical block split information, a macroblock type, SAO mode information, or the like) included in the bit streams used in the decoding to the area splitting section 221.

In Step S202, the MV converter 121 performs normalization in the direction from the encoding order to the display order or the like based on the motion vector information from the decoding section 111, performs signal processing, and thereby converts the information into a motion vector that is available for respective sections in the later stage. The MV converter 121 supplies the converted motion vector to the area splitting section 221 and the dynamic image processor 123.

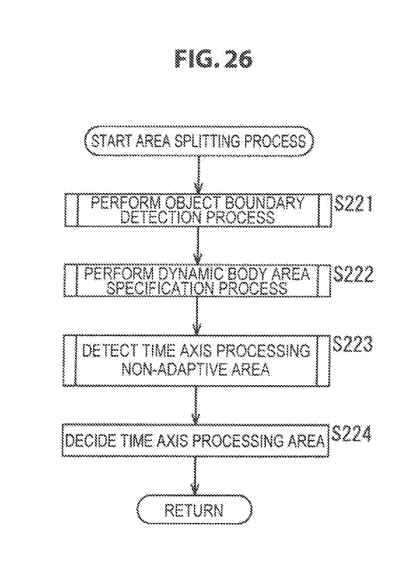

In Step S203, the area splitting section 221 performs an area splitting process using the hierarchical block split information, the motion vector, information of the decoded image, and the like. This area splitting process will be described below with reference to FIG. 26.

The area splitting process is performed through Step S203, and information of split areas is supplied to the dynamic image processor 123.

In Step S204, the dynamic image processor 123 performs the high image quality process such as the frame number interpolation process or noise reduction on the decoded image from the decoding section 111 based on the information on the split areas from the area splitting section 221, and the motion vector from the MV converter 121. The dynamic image processor 123 outputs a high-quality image which is the result of the high image quality process to the outside.

[Area Splitting Process]

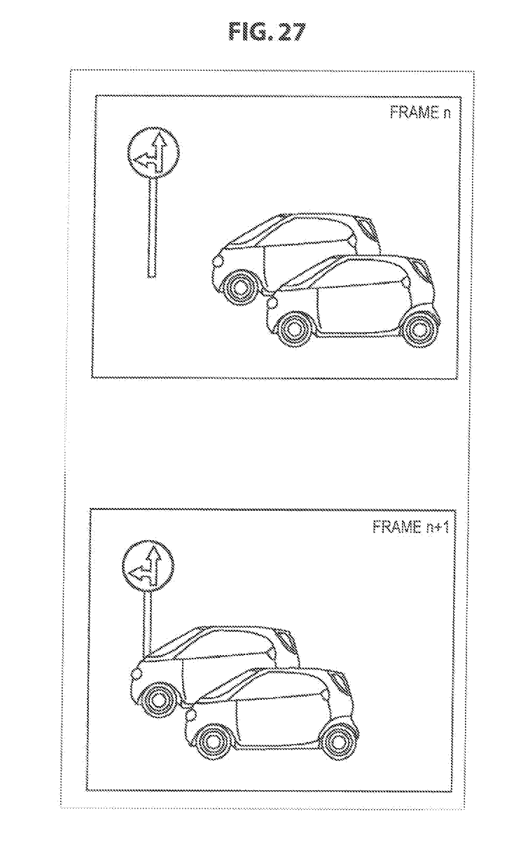

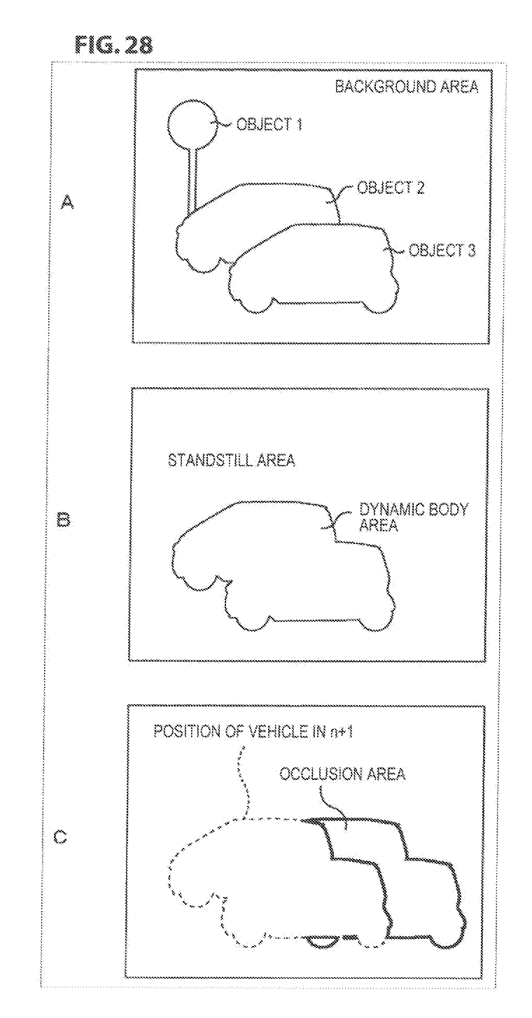

Next, the area splitting process of Step S203 of FIG. 25 will be described with reference to the flowchart of FIG. 26, and FIGS. 27 and 28. For example, an example in which any high image quality process is performed on a frame n+1 using information of a frame n of a dynamic image in which two vehicles are running side by side as shown in FIG. 27 will be described.

The decoded image from the decoding section 111 is input to the object boundary detector 231, the dynamic body area detector 122, and the time axis processing non-adaptive area deciding section 232. In addition, the CU/TU split information included in the encoded information from the decoding section 111 is input to the object boundary detector 231. The PU split information included in the encoded information from the decoding section 111 is input to the dynamic body area detector 122. Information of the macroblock type and the SAO mode included in the encoded information from the decoding section 111 is supplied to the time axis processing non-adaptive area deciding section 232.

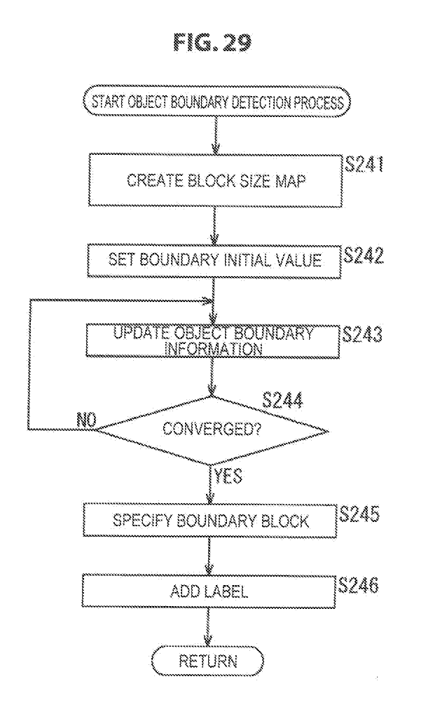

The object boundary detector 231 detects object boundary information based on the decoded image and CU/TU split information in Step S221. The process of detecting the object boundary will be described below with reference to FIG. 29. Through Step S221, the object boundary information is acquired from the decoded image of the frame n+1 using the CU/TU split information. For example, the object boundary information is acquired in units of Object 1 (sign), Object 2 (vehicle), and Object 3 (vehicle) as shown in A of FIG. 28. The acquired object boundary information is supplied to the time axis processing area deciding section 233.

In Step S222, the dynamic body area detector 122 performs a dynamic body area specification process using the hierarchical block split information, motion vector, information of the decoded image, and the like. Since this dynamic body area specification process is basically the same as the process described above with reference to FIG. 16, repetitive description thereof will be omitted.

Through Step S222, the boundary information of areas having a uniform motion is detected from the decoded image of the frame n+1 using the PU split information and the motion vector. For example, the image is split into a standstill area and a dynamic body area as shown in B of FIG. 28. Information of the specified dynamic body area is supplied to the time axis processing area deciding section 233 through Step S222.

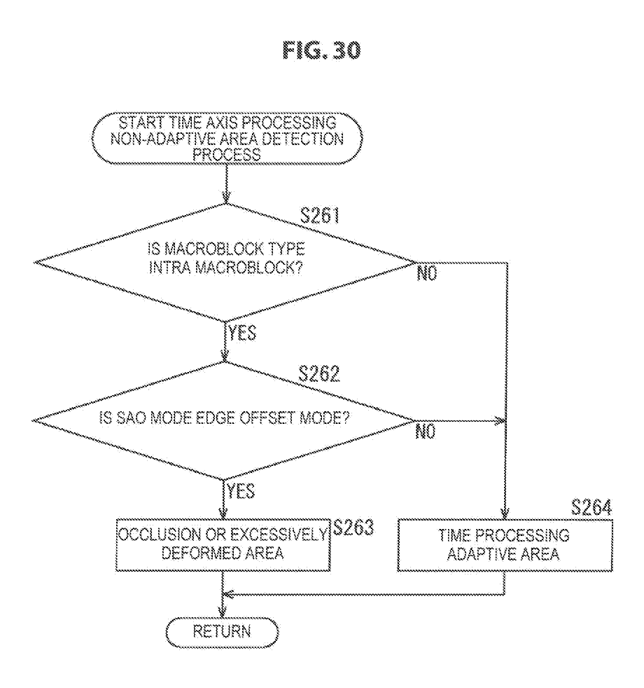

In Step S223, the time axis processing non-adaptive area deciding section 232 detects an area such as an occlusion or an excessively deformed area to which the time axis process is not applicable from the decoded image based on the information of the macroblock type and SAO mode. The process of detecting the time axis processing non-adaptive area will be described below with reference to FIG. 30. Through Step S223, an occlusion area or the like which appears due to a movement of a vehicle can be detected in the frame N+1 as shown in C of FIG. 28.

Information of the occlusion or the excessively deformed area detected by the time axis processing non-adaptive area deciding section 232 is supplied to the time axis processing area deciding section 233 as a feeling of a time axis processing non-adaptive area.

The time axis processing area deciding section 233 decides a final time axis processing area based on the object boundary information, information of the dynamic body area, and information of the time axis processing non-adaptive area, and generates an area map for the decision of a time axis processing non-adaptive area in Step S224.

Information of the area map generated from Step S224 is supplied to the dynamic image processor 123 of FIG. 22. Accordingly, the dynamic image processor 123 can prohibit the time axis process in a processing-free area when the time axis processing is not suitable, and thus image failure caused by the time axis process can be prevented.

[Object Boundary Detection Process]

Next, the object boundary detection process of Step S221 of FIG. 26 will be described with reference to the flowchart of FIG. 29. Since Steps S241 to S245 of FIG. 29 are basically the same as Steps S151 to S156 of FIG. 17, description thereof will be omitted.

Thus, labels are added to areas of respective objects in Step S245, and then information of the areas of the respective objects to which the labels have been added is supplied to the time axis processing area deciding section 233.

Note that, when there are a plurality of objects as well in the process of FIG. 29, the plurality of objects can be split by setting different initial values and performing an arithmetic operation of convergence.

[Time Axis Processing Non-Adaptive Area Detection Process]

Next, the time axis processing non-adaptive area detection process of Step S223 of FIG. 26 will be described with reference to the flowchart of FIG. 30.

In Step S261, the time axis processing non-adaptive area deciding section 232 determines whether or not the macroblock type from the decoding section 11 is an intra macroblock. When it is determined to be an intra macroblock in Step S261, the process proceeds to Step S262.

In Step S262, the time axis processing non-adaptive area deciding section 232 determines whether or not the SAO mode from the decoding section 111 is an edge offset mode. When it is determined to be an edge offset mode in Step S262, the process proceeds to Step S263.

In Step S263, the time axis processing non-adaptive area deciding section 232 assumes the macroblock to be an occlusion or an excessively deformed area.

On the other hand, when the macroblock is determined not to be an intra macroblock, i.e., to be an inter macroblock, in Step S261, the process proceeds to Step S264. In addition, when the SAO mode is determined not to be the edge offset mode, i.e., to be a band offset mode, in Step S262, the process proceeds to Step S264.

In Step S264, the time axis processing non-adaptive area deciding section 232 assumes the macroblock to be a time process applicable area.

[Time Axis Processing Area Decision Process]

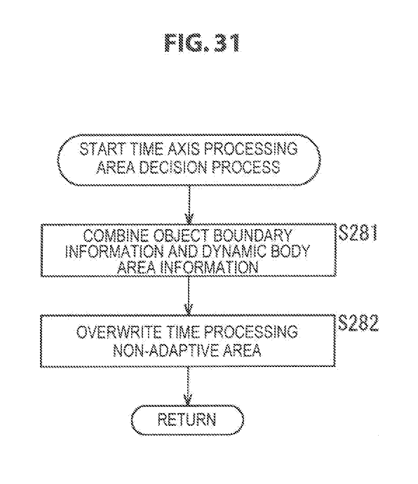

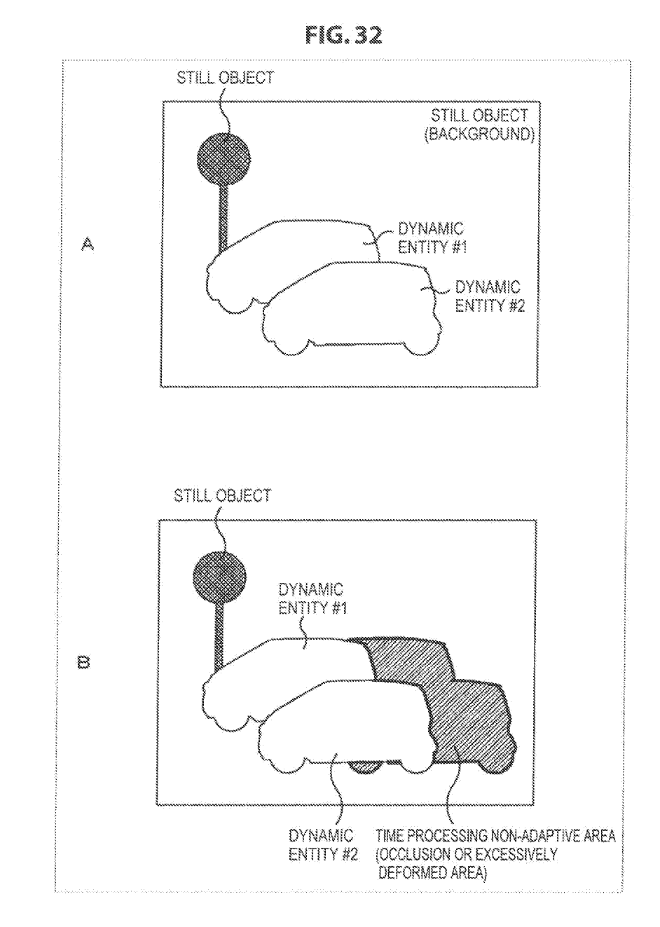

Next, another example of the time axis processing area decision process of Step S224 of FIG. 26 will be described with reference to the flowchart of FIG. 31 and FIG. 32. In other words, the time axis processing area deciding section 233 is described as performing only decision of a time processing non-adaptive area in Step S224 above; however, the section can also decide other areas and supply information of a decided area.

In Step S281, the time axis processing area deciding section 233 combines the object boundary information from the object boundary detector 231 and information of the dynamic body area from the dynamic body area detector 122. In other words, each object is assigned to be a dynamic body object (dynamic entity) and a still object (still entity) on the object boundary information detected from CU/TU as shown in A of FIG. 32 referring to splitting of the dynamic body area detected from the PU and the motion vector.

In Step S282, the time axis processing area deciding section 233 overwrites the time processing non-adaptive area from the time axis processing non-adaptive area deciding section 232 on the area information combined in Step S281.

Accordingly, a time processing area map in which respective objects are classified into a dynamic entity area, a still entity area, and a time processing non-adaptive area is generated as shown in B of FIG. 32.

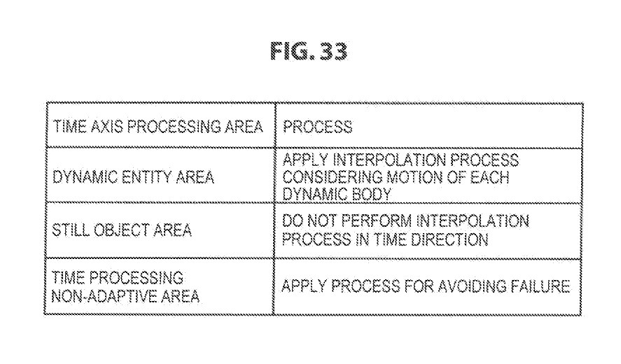

The time processing area map is supplied to the dynamic image processor 123. For example, in the frame number interpolation process (high frame-rate process), the dynamic image processor 123 applies the process shown in FIG. 33 in addition to the standard high image quality process according to the result of the classified areas.

In other words, when an area is a dynamic entity area, the dynamic image processor 123 applies an interpolation process in which motions of each dynamic body are considered. When an area is a still entity area, the dynamic image processor 123 does not perform the interpolation process in the time direction. When an area is the time processing non-adaptive process, a process for avoiding failure is applied.

Since the high image quality process is performed on the processing areas differently as described above, image quality can be further improved.

Note that, although an example of the image processing device which configures a decoder of the HEVC standard has been described above, an encoding method of a decoder is not limited to the HEVC standard. The present technology can be applied when an encoding parameter is used for encoding performed using an encoding method which has, for example, a hierarchical structure and performs filtering such as an edge offset, a band offset, and the like.

### 3. Third Embodiment

### Computer

The above described series of processes can be executed by hardware or can be executed by software. When the series of processes are to be performed by software, the programs forming the software are installed in a computer. Here, a computer includes a computer which is incorporated in dedicated hardware or a general-purpose personal computer (PC) which can execute various functions by installing various programs into the computer, for example.

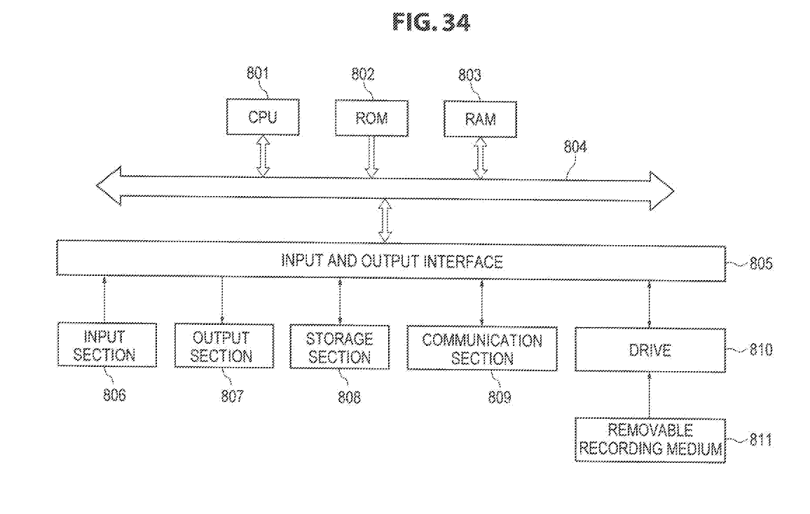

FIG. 34 is a block diagram illustrating a configuration example of hardware of a computer for executing the above-described series of processes through a program.

In a computer 800, a central processing unit (CPU) 801, a read only memory (ROM) 802, and a random access memory (RAM) 803 are connected to one another by a bus 804.

An input and output interface 805 is further connected to the bus 804. An input section 806, an output section 807, a storage section 808, a communication section 809, and a drive 810 are connected to the input and output interface 805.

The input section 806 is formed with a keyboard, a mouse, a microphone, and the like. The output section 807 is formed with a display, a speaker, and the like. The storage section 808 is formed with a hard disk, a RAM disk, a nonvolatile memory, or the like. The communication section 809 is formed with a network interface, or the like. The drive 810 drives a removable recording medium 811 such as a magnetic disk, an optical disc, a magneto-optical disc, or a semiconductor memory.

In the computer configured as described above, the CPU 801 loads the program stored in the storage section 808 into the RAM 803 via the input and output interface 805 and the bus 804, and executes the program so that the above described series of processes are performed.

The program executed by the computer 800 (the CPU 801) may be provided by being recorded on the removable recording medium 811 as a packaged medium or the like. The program can also be applied via a wired or wireless transfer medium, such as a local area network, the Internet, or a digital satellite broadcast.

In the computer, by loading the removable recording medium 811 into the drive 810, the program can be installed into the storage section 808 via the input and output interface 805. It is also possible to receive the program from a wired or wireless transfer medium using the communication section 809 and install the program into the storage section 808. As another alternative, the program can be installed in advance into the ROM 802 or the storage section 808.

It should be noted that the program executed by a computer may be a program that is processed in time series according to the sequence described in this specification or a program that is processed in parallel or at a necessary timing such as upon calling.

In the present disclosure, steps of describing the program to be recorded on the recording medium may include processes performed in time-series according to the description order and processes not performed in time-series but performed in parallel or individually.

Further, in this specification, “system” refers to a whole device composed of a plurality of devices.

Further, an element described as a single device (or processing unit) above may be divided and configured as a plurality of devices (or processing units). On the contrary, elements described as a plurality of devices (or processing units) above may be configured collectively as a single device (or processing unit). Further, an element other than those described above may be added to each device (or processing unit). Furthermore, a part of an element of a given device (or processing unit) may be included in an element of another device (or another processing unit) as long as the configuration or operation of the system as a whole is substantially the same. The present technology is not limited to the embodiments described above, and various changes and modifications may be made without departing from the scope of the present technology.

An embodiment of the disclosure is not limited to the embodiments described above, and various changes and modifications may be made without departing from the scope of the present technology.

For example, the present technology can adopt a configuration of cloud computing which performs processing by allocating and sharing one function to and with a plurality of apparatuses through a network.

Further, each step described by the above-mentioned flow charts can be executed by one apparatus or by being shared with a plurality of apparatuses.

In addition, in the case in which a plurality of processes is included in one step, the plurality of processes included in this one step can be executed by one apparatus or by being shared with a plurality of apparatuses.

The image encoding device and the image decoding device according to the embodiments described above can be applied to various electronic appliances such as a transmitter and a receiver for satellite broadcasting, cable broadcasting of a cable TV, distribution on the Internet, distribution to terminals via cellular communication, and the like, a recording device that records images in a medium such as an optical disc, a magnetic disk or a flash memory, a reproduction device that reproduces images from such storage medium. Four application examples will be described below.

### APPLICATION EXAMPLES

### First Application Example

### Television Receiver

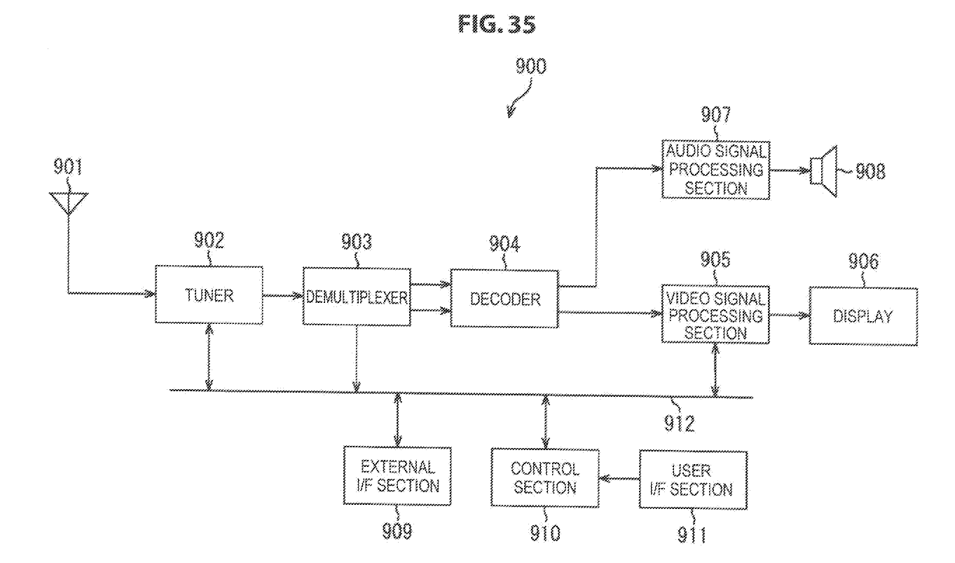

FIG. 35 illustrates an example of a schematic configuration of a television device to which the aforementioned embodiment is applied. A television device 900 includes an antenna 901, a tuner 902, a demultiplexer 903, a decoder 904, a video signal processing section 905, a display 906, an audio signal processing section 907, a speaker 908, an external interface 909, a control section 910, a user interface 911, and a bus 912.

The tuner 902 extracts a signal of a desired channel from a broadcast signal received through the antenna 901 and demodulates the extracted signal. The tuner 902 then outputs an encoded bit stream obtained by the demodulation to the demultiplexer 903. That is, the tuner 902 has a role as a transmission means receiving the encoded stream in which an image is encoded, in the television device 900.

The demultiplexer 903 separates a video stream and an audio stream of a program to be viewed from the encoded bit stream and outputs each of the separated streams to the decoder 904. The demultiplexer 903 also extracts auxiliary data such as an electronic program guide (GEP) from the encoded bit stream and supplies the extracted data to the control section 910. Here, the demultiplexer 903 may descramble the encoded bit stream when it is scrambled.

The decoder 904 decodes the video stream and the audio stream that are input from the demultiplexer 903. The decoder 904 then outputs video data generated from the decoding process to the video signal processing section 905. Furthermore, the decoder 904 outputs audio data generated in the decoding process to the audio signal processing section 907.

The video signal processing section 905 reproduces the video data input from the decoder 904 and displays the video on the display 906. The video signal processing section 905 may also display an application screen supplied through the network on the display 906. The video signal processing section 905 may further perform an additional process, for example, noise reduction (suppression) on the video data according to the setting. Furthermore, the video signal processing section 905 may generate an image of a graphical user interface (GUI) such as a menu, a button, or a cursor and superpose the generated image onto the output image.

The display 906 is driven by a drive signal supplied from the video signal processing section 905 and displays a video or an image on a video screen of a display device (such as a liquid crystal display, a plasma display, or an organic electroluminescence display (OELD) (organic EL display), etc.).

The audio signal processing section 907 performs a reproduction process such as D-A conversion and amplification on the audio data input from the decoder 904 and outputs the audio from the speaker 908. The audio signal processing section 907 may also perform an additional process such as noise reduction (suppression) on the audio data.

The external interface 909 is an interface for connecting the television device 900 with an external device or a network. For example, the decoder 904 may decode a video stream or an audio stream received through, for example, the external interface 909. In other words, the external interface 909 also has a role as the transmission means receiving the encoded stream in which an image is encoded, in the television device 900.

The control section 910 includes a processor such as a central processing unit (CPU) and a memory such as a random access memory (RAM) and a read only memory (ROM). The memory stores a program executed by the CPU, program data, EPG data, and data acquired through the network. The program stored in the memory is read by the CPU at the start-up of the television device 900 and executed, for example. By executing the program, the CPU controls operations of the television device 900 in accordance with an operation signal that is input from the user interface 911, for example.

The user interface 911 is connected to the control section 910. The user interface 911 includes a button and a switch for a user to operate the television device 900 as well as a reception part of a remote control signal, for example. The user interface 911 detects a user operation through these components, generates the operation signal, and outputs the generated operation signal to the control section 910.

The bus 912 connects the tuner 902, the demultiplexer 903, the decoder 904, the video signal processing section 905, the audio signal processing section 907, the external interface 909, and the control section 910 to each other.

In the television device 900 configured as described above, the decoder 904 has the function of the image processing device which uses the encoded information according to the embodiments. Thus, when an image is decoded in the television device 900, a high image quality process can be performed with higher efficiency.

### Second Application Example

### Mobile Telephone

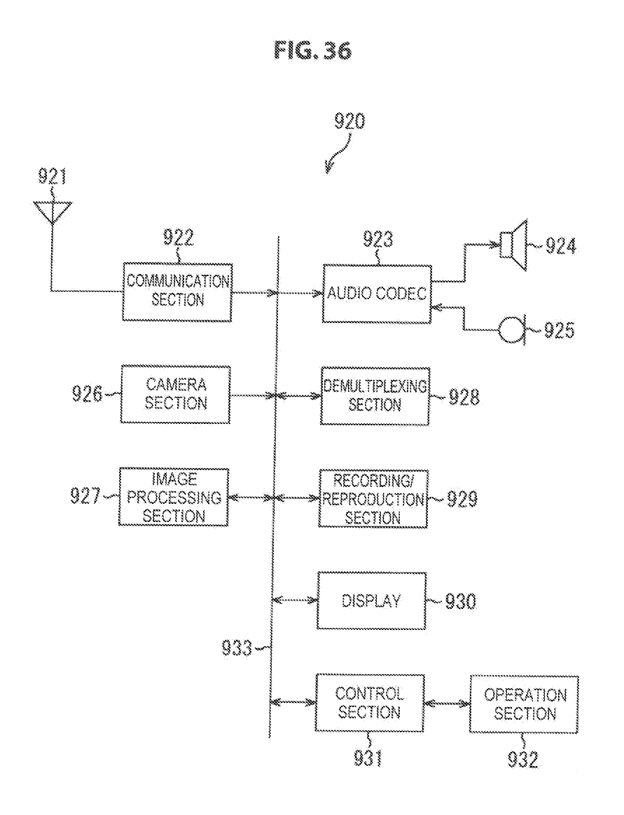

FIG. 36 illustrates an example of a schematic configuration of a mobile telephone to which the aforementioned embodiment is applied. A mobile telephone 920 includes an antenna 921, a communication section 922, an audio codec 923, a speaker 924, a microphone 925, a camera section 926, an image processing section 927, a multiplexing and separation section 928, a recording and reproduction section 929, a display 930, a control section 931, an operation section 932, and a bus 933.

The antenna 921 is connected to the communication section 922. The speaker 924 and the microphone 925 are connected to the audio codec 923. The operation section 932 is connected to the control section 931. The bus 933 connects the communication section 922, the audio codec 923, the camera section 926, the image processing section 927, the multiplexing and separation section 928, the recording and reproduction section 929, the display 930, and the control section 931 to each other.

The mobile telephone 920 performs operations such as transmitting/receiving an audio signal, transmitting/receiving an electronic mail or image data, imaging an image, and recording data in various operation modes including an audio call mode, a data communication mode, a photography mode, and a videophone mode.

In the audio call mode, an analog audio signal generated by the microphone 925 is supplied to the audio codec 923. The audio codec 923 then converts the analog audio signal into audio data, performs A-D conversion on the converted audio data, and compresses the data. The audio codec 923 thereafter outputs the compressed audio data to the communication section 922. The communication section 922 encodes and modulates the audio data to generate a transmission signal. The communication section 922 then transmits the generated transmission signal to a base station (not illustrated) through the antenna 921. Furthermore, the communication section 922 amplifies a radio signal received through the antenna 921, converts a frequency of the signal, and acquires a reception signal. The communication section 922 thereafter demodulates and decodes the reception signal to generate the audio data and outputs the generated audio data to the audio codec 923. The audio codec 923 decompresses the audio data, performs D-A conversion on the data, and generates the analog audio signal. The audio codec 923 then outputs the audio by supplying the generated audio signal to the speaker 924.

In addition, in the data communication mode, for example, the control section 931 generates character data constituting an electronic mail, in accordance with a user operation through the operation section 932. The control section 931 further causes characters to be displayed on the display 930. Moreover, the control section 931 generates electronic mail data in accordance with a transmission instruction from a user through the operation section 932 and outputs the generated electronic mail data to the communication section 922. The communication section 922 encodes and modulates the electronic mail data to generate a transmission signal. Then, the communication section 922 transmits the generated transmission signal to the base station (not illustrated) through the antenna 921. The communication section 922 further amplifies a radio signal received through the antenna 921, converts a frequency of the signal, and acquires a reception signal. The communication section 922 thereafter demodulates and decodes the reception signal, restores the electronic mail data, and outputs the restored electronic mail data to the control section 931. The control section 931 causes the content of the electronic mail to be displayed on the display 930 as well as the electronic mail data to be stored in a storage medium of the recording and reproduction section 929.

The recording and reproduction section 929 includes an arbitrary readable and writable storage medium. For example, the storage medium may be a built-in storage medium such as a RAM or a flash memory, or may be an externally-mounted storage medium such as a hard disk, a magnetic disk, a magneto-optical disc, an optical disc, a universal serial bus (USB) memory, or a memory card.

In the photography mode, for example, the camera section 926 images an object, generates image data, and outputs the generated image data to the image processing section 927. The image processing section 927 encodes the image data input from the camera section 926 and stores an encoded stream in the storage medium of the storage and reproduction section 929.

In addition, in the videophone mode, for example, the multiplexing and separation section 928 multiplexes a video stream encoded by the image processing section 927 and an audio stream input from the audio codec 923, and outputs the multiplexed streams to the communication section 922. The communication section 922 encodes and modulates the streams to generate a transmission signal. The communication section 922 then transmits the generated transmission signal to the base station (not illustrated) through the antenna 921. Moreover, the communication section 922 amplifies a radio signal received through the antenna 921, converts a frequency of the signal, and acquires a reception signal. The transmission signal and the reception signal can include an encoded bit stream. Then, the communication section 922 demodulates and decodes the reception signal to restore the stream, and outputs the restored stream to the multiplexing and separation section 928. The multiplexing and separation section 928 separates the video stream and the audio stream from the input stream and outputs the video stream and the audio stream to the image processing section 927 and the audio codec 923, respectively. The image processing section 927 decodes the video stream to generate video data. The video data is then supplied to the display 930, and thereby the display 930 displays a series of images. The audio codec 923 decompresses and performs D-A conversion on the audio stream to generate an analog audio signal. The audio codec 923 then supplies the generated audio signal to the speaker 924 to output the audio.

In the mobile telephone 920 configured as described above, the image processing section 927 has the function of the image processing device with the motion detector and the image processing device that uses encoded information according to the embodiments. Thus, when an image is encoded and decoded in the mobile telephone 920, a high image quality process can be performed with higher efficiency.

### Third Application

### Recording and Reproduction Device

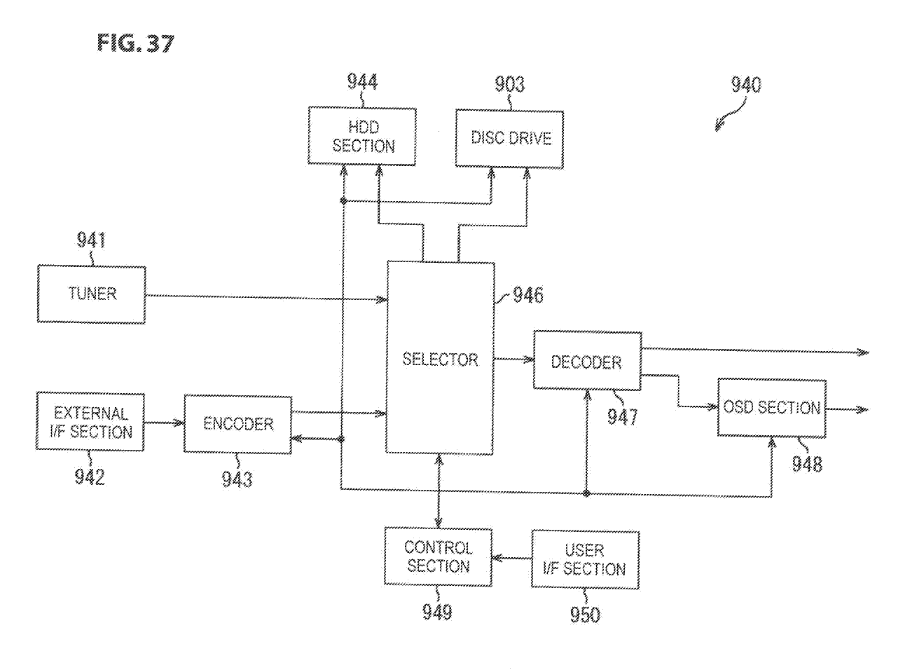

FIG. 37 illustrates an example of a schematic configuration of a recording and reproduction device to which the aforementioned embodiment is applied. The recording and reproduction device 940 encodes audio data and video data of a received broadcast program and records the data into a recording medium, for example. The recording and reproduction device 940 may also encode audio data and video data acquired from another device and record the data into the recording medium, for example. In addition, in response to a user instruction, for example, the recording and reproduction device 940 reproduces the data recorded in the recording medium on a monitor and from a speaker. The recording and reproduction device 940 at this time decodes the audio data and the video data.

The recording and reproduction device 940 includes a tuner 941, an external interface 942, an encoder 943, a hard disk drive (HDD) 944, a disk drive 945, a selector 946, a decoder 947, an on-screen display (OSD) 948, a control section 949, and a user interface 950.

The tuner 941 extracts a signal of a desired channel from a broadcast signal received through an antenna (not illustrated) and demodulates the extracted signal. The tuner 941 then outputs an encoded bit stream obtained from the demodulation to the selector 946. That is, the tuner 941 has a role as a transmission means in the recording and reproduction device 940.

The external interface 942 is an interface for connecting the recording and reproduction device 940 with an external device or a network. The external interface 942 may be, for example, an IEEE 1394 interface, a network interface, a USB interface, or a flash memory interface. The video data and the audio data received through the external interface 942 are input to the encoder 943, for example. That is, the external interface 942 has a role as a transmission means in the recording and reproduction device 940.

The encoder 943 encodes the video data and the audio data when the video data and the audio data input from the external interface 942 are not encoded. The encoder 943 thereafter outputs an encoded bit stream to the selector 946.

The HDD 944 records the encoded bit stream in which content data such as video and audio is compressed, various programs, and other data into an internal hard disk. In addition, the HDD 944 reads these data from the hard disk when reproducing the video and the audio.

The disk drive 945 records and reads data into and from a recording medium which is mounted to the disk drive. The recording medium mounted to the disk drive 945 may be, for example, a DVD disc (such as DVD-Video, DVD-RAM, DVD-R, DVD-RW, DVD+R, or DVD+RW) or a Blu-ray (registered trademark) disk.

The selector 946 selects the encoded bit stream input from the tuner 941 or the encoder 943 when recording the video and audio, and outputs the selected encoded bit stream to the HDD 944 or the disk drive 945. In addition, when reproducing the video and audio, the selector 946 outputs the encoded bit stream input from the HDD 944 or the disk drive 945 to the decoder 947.

The decoder 947 decodes the encoded bit stream to generate the video data and the audio data. Then, the decoder 947 outputs the generated video data to the OSD 948. In addition, the decoder 947 outputs the generated audio data to an external speaker.

The OSD 948 reproduces the video data input from the decoder 947 and displays the video. The OSD 948 may also superpose an image of a GUI, for example, a menu, a button, or a cursor on the displayed video.

The control section 949 includes a processor such as a CPU and a memory such as a RAM and a ROM. The memory stores a program executed by the CPU as well as program data. The program stored in the memory is read by the CPU at the start-up of the recording and reproduction device 940 and executed, for example. By executing the program, the CPU controls operations of the recording and reproduction device 940 in accordance with an operation signal that is input from the user interface 950, for example.

The user interface 950 is connected to the control section 949. The user interface 950 includes a button and a switch for a user to operate the recording and reproduction device 940 as well as a reception part of a remote control signal, for example. The user interface 950 detects a user operation through these components, generates the operation signal, and outputs the generated operation signal to the control section 949.

In the recording and reproduction device 940 configured as described above, the encoder 943 has the function of the image processing device with the motion detector according to the above-described embodiments. In addition, the decoder 947 has the function of the image decoding device according to the above-described embodiments. Thus, when an image is encoded and decoded in the recording and reproduction device 940, a high image quality process can be performed with higher efficiency.

### Fourth Application

### Imaging Device

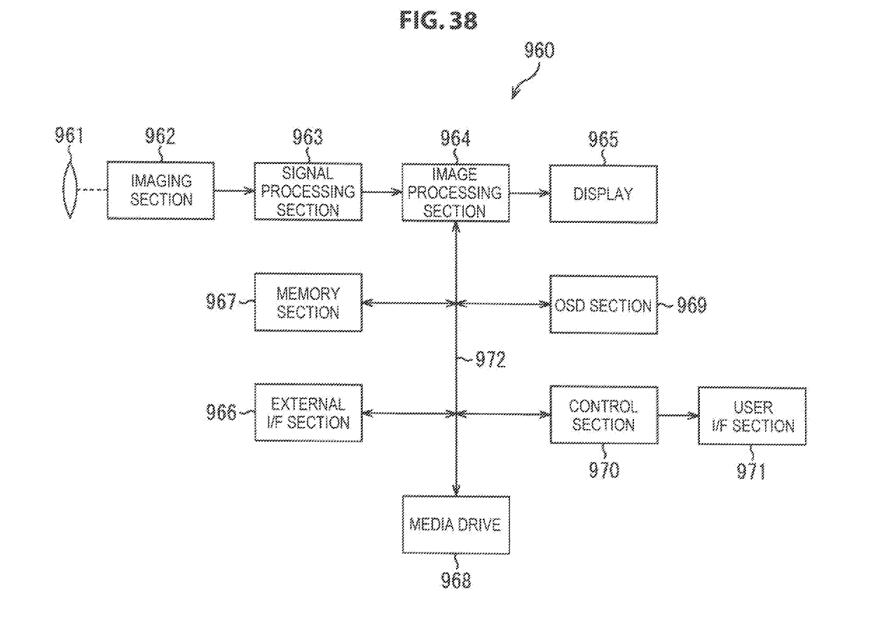

FIG. 38 illustrates an example of a schematic configuration of an imaging device to which the aforementioned embodiment is applied. The imaging device 960 images an object, generates an image, encodes image data, and records the data into a recording medium.

The imaging device 960 includes an optical block 961, an imaging section 962, a signal processing section 963, an image processing section 964, a display 965, an external interface 966, a memory 967, a media drive 968, an OSD 969, a control section 970, a user interface 971, and a bus 972.

The optical block 961 is connected to the imaging section 962. The imaging section 962 is connected to the signal processing section 963. The display 965 is connected to the image processing section 964. The user interface 971 is connected to the control section 970. The bus 972 connects the image processing section 964, the external interface 966, the memory 967, the media drive 968, the OSD 969, and the control section 970 to each other.

The optical block 961 includes a focus lens and a diaphragm mechanism. The optical block 961 forms an optical image of a subject on an imaging surface of the imaging section 962. The imaging section 962 includes an image sensor such as a charge coupled device (CCD) or a complementary metal oxide semiconductor (CMOS) and performs photoelectric conversion to convert the optical image formed on the imaging surface into an image signal as an electric signal. Then, the imaging section 962 outputs the image signal to the signal processing section 963.

The signal processing section 963 performs various camera signal processes such as knee correction, gamma correction and color correction on the image signal input from the imaging section 962. The signal processing section 963 outputs the image data, on which the camera signal process has been performed, to the image processing section 964.

The image processing section 964 encodes the image data input from the signal processing section 963 to generate the encoded data. The image processing section 964 then outputs the generated encoded data to the external interface 966 or the media drive 968. The image processing section 964 also decodes the encoded data input from the external interface 966 or the media drive 968 to generate image data. The image processing section 964 then outputs the generated image data to the display 965. Moreover, the image processing section 964 may output to the display 965 the image data input from the signal processing section 963 to display the image. Furthermore, the image processing section 964 may superpose display data acquired from the OSD 969 on the image that is output on the display 965.

The OSD 969 generates an image of a GUI, for example, a menu, a button, or a cursor and outputs the generated image to the image processing section 964.

The external interface 966 is configured as a USB input and output terminal, for example. The external interface 966 connects the imaging device 960 with a printer when printing an image, for example. Moreover, a drive is connected to the external interface 966 as needed. A removable medium such as a magnetic disk or an optical disc is mounted to the drive, for example, so that a program read from the removable medium can be installed in the imaging device 960. The external interface 966 may also be configured as a network interface that is connected to a network such as a LAN or the Internet. That is, the external interface 966 has a role as a transmission means in the imaging device 960.

The recording medium mounted to the media drive 968 may be an arbitrary readable and writable removable medium, for example, a magnetic disk, a magneto-optical disc, an optical disc, or a semiconductor memory. Furthermore, the recording medium may be fixedly mounted to the media drive 968 so that a non-transportable storage unit such as a built-in hard disk drive or a solid state drive (SSD) is configured, for example.

The control section 970 includes a processor such as a CPU and a memory such as a RAM and a ROM. The memory stores a program executed by the CPU as well as program data. The program stored in the memory is read by the CPU at, for example, the start-up of the imaging device 960 and then executed. By executing the program, the CPU controls operations of the imaging device 960 in accordance with an operation signal that is input from the user interface 971, for example.

The user interface 971 is connected to the control section 970. The user interface 971 includes a button and a switch for a user to operate the imaging device 960, for example. The user interface 971 detects a user operation through these components, generates the operation signal, and outputs the generated operation signal to the control section 970.

In the imaging device 960 configured as described above, the image processing section 964 has the function of the image processing device with the motion detector and the image processing device that uses encoded information according to the above-described embodiments. Thus, when an image is encoded and decoded in the imaging device 960, a high image quality process can be performed with higher efficiency.

### Fourth Embodiment

### Other Examples

Although examples of a device, a system, and the like to which the present technology is applied have been described above, the present technology is not limited thereto, and they can be realized as all configurations mounted in devices constituting such a device or system, for example, a processor as a system large scale integration (LSI), a module that uses a plurality or processors and the like, a unit that uses a plurality of modules and the like, and a set obtained by adding other functions to such a unit (i.e., a partial configuration of a device) and the like.

### [Video Set]

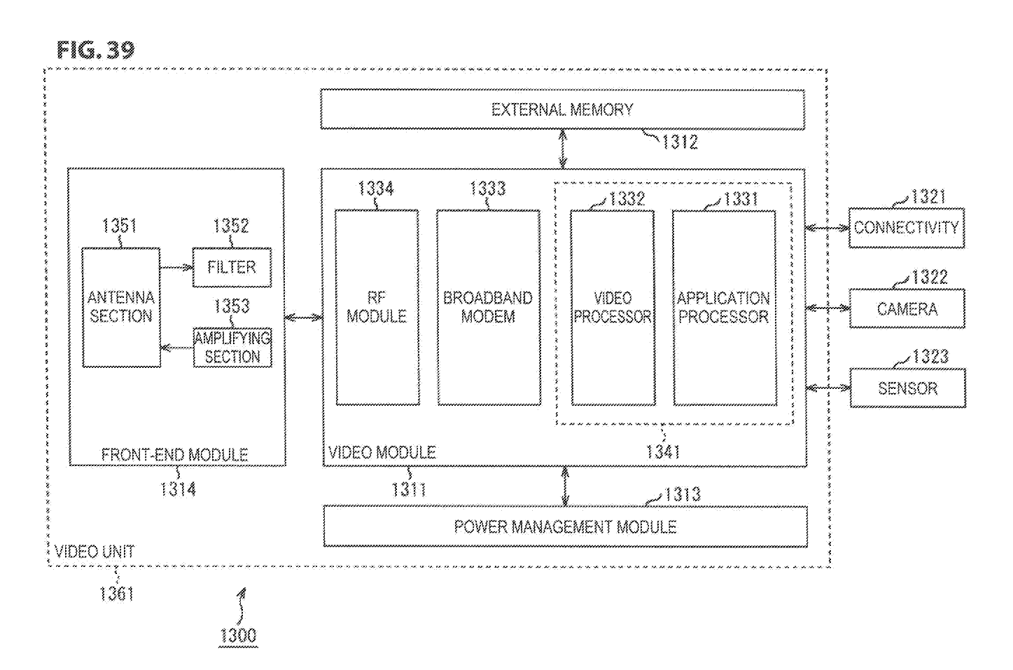

An example in which the present technology is implemented as a set will be described with reference to FIG. 39. FIG. 39 shows the example of a schematic configuration of a video set to which the present technology is applied.

As electronic apparatuses have become multifunctional in recent years, there are many cases of development and manufacturing in which, when a partial configuration of such an electronic apparatus is subject to sales, provision, and the like, the configuration is attained not only as a configuration having one function but also one set with a plurality of functions by combining a plurality of configurations with related functions.

The video set 1300 shown in FIG. 39 is configured to be multifunctional as described above, by combining a device having the function relating to encoding and decoding of images (either or both of them may be possible) with a device having another function relating to the foregoing function.

As shown in FIG. 39, the video set 1300 has a module group including a video module 1311, an external memory 1312, a power management module 1313, and a front-end module 1314 and a device having functions relating to connectivity 1321, a camera 1322, a sensor 1323, and the like.

A module is a component which has an organized function in which several componential functions relating to each other are collected. Although a specific physical configuration thereof is arbitrary, for example, one in which a plurality of processors having different functions, electronic circuit elements such as a resist or a capacitor, and other devices are arranged in a wiring substrate to be integrated is considered. In addition, configuring a new module by combining a module with another module or a processor can also be considered.

In the example of FIG. 39, the video module 1311 is a combination of configurations with functions relating to image processing, and has an application processor, a video processor, a broadband modem 1333, and an RF module 1334.

A processor is an integration of configurations having predetermined functions to be integrated on a semiconductor chip through System-on-Chip (SoC), and there is one called, for example, system large scale integration (LSI). A configuration having a predetermined function may be a logical circuit (hardware configuration), may be a CPU, a ROM, or a RAM, and a program which is executed using them (software configuration), or may be a combination of both configurations. For example, a processor may have a logical circuit, a CPU, a ROM, and a RAM, realize some functions thereof with the logical circuit (hardware configuration), and realize other functions thereof with a program executed in the CPU (software configuration).

The application processor 1331 of FIG. 39 is a processor which executes an application relating to image processing. The application executed by the application processor 1331 can not only perform an arithmetic process but also control another configuration inside and outside the video module 1311, for example, the video processor 1332, to realize a predetermined function.

The video processor 1332 is a processor with the function relating to (either or both of) encoding and decoding of images.

The broadband modem 1333 is a processor (or a module) which performs a process relating to wired or wireless broadband communication (or both) conducted through a broadband line such as the Internet or a public telephone network. The broadband modem 1333, for example, converts transmitted data (a digital signal) into an analog signal by performing digital modulation or the like, or decodes and converts a received analog signal into data (a digital signal). The broadband modem 1333, for example, can perform digital modulation and demodulation on arbitrary information such as image data processed by the video processor 1332 or streams obtained by encoding image data, an application program, set data, or the like.

The RF module 1334 is a module which performs frequency conversion, modulation and demodulation, amplification, a filtering process, and the like on radio frequency (RF) signals transmitted or received via an antenna. The RF module 1334, for example, generates RF signals by performing frequency conversion or the like on baseband signals generated by the broadband modem 1333. In addition, the RF module 1334, for example, generates baseband signals by performing frequency conversion or the like on RF signals received via the front-end module 1314.

Note that, as indicated by the dotted line 1341 in FIG. 39, the application processor 1331 and the video processor 1332 may be integrated and configured as one processor.

The external memory 1312 is a module which is provided outside the video module 1311 and has a storage device used by the video module 1311. The storage device of the external memory 1312 may be realized with any physical configuration, but is often used for storing a large volume of data such as image data in units of frames in general, and thus it is desirable to realize the device as a comparatively inexpensive large-capacity semiconductor memory, for example, a dynamic random access memory (DRAM).

The power management module 1313 manages and controls power supply to the video module 1311 (each configuration included in the video module 1311).

The front-end module 1314 is a module which provides a front-end function (a transmission and reception terminal circuit on an antenna side) to the RF module 1334. As shown in FIG. 39, the front-end module 1314 has, for example, an antenna section 1351, a filter 1352, and an amplifying section 1353.

The antenna section 1351 has an antenna which transmits and receives radio signals and a peripheral configuration thereof. The antenna section 1351 transmits a signal supplied from the amplifying section 1353 as a radio signal and supplies the received radio signal to the filter 1352 as an electric signal (RF signal). The filter 1352 performs a filtering process or the like on the RF signal received via the antenna section 1351, and supplies the processed RF signal to the RF module 1334. The amplifying section 1353 amplifies the RF signal supplied from the RF module 1334 and then supplies the signal to the antenna section 1351.

The connectivity 1321 is a module with a function relating to connection with the outside. A physical configuration of the connectivity 1321 is arbitrary. The connectivity 1321, for example, has a configuration with a communication function of a communication standard other than that applicable to the broadband modem 1333, an external input and output terminal, and the like.

The connectivity 1321 may have, for example, a module with a communication function based on a wireless communication standard such as Bluetooth (registered trademark), IEEE 802.11 (for example, Wireless Fidelity (Wi-Fi; registered trademark)), near field communication (NFC), or Infrared Data Association (IrDA), an antenna which transmits and receives signals based on the standard, or the like. In addition, the connectivity 1321 may have, for example, a module with a communication function based on a wired communication standard such as Universal Serial Bus (USB), or High-Definition Multimedia Interface (HDMI; registered trademark), or a terminal based on the standard. Furthermore, the connectivity 1321 may have, for example, another data (signal) transmission function such as an analog input and output terminal.

Note that the connectivity 1321 may include a device of a data (signal) transmission destination. The connectivity 1321 may have, for example, a drive which reads and writes data on a recording medium such as a magnetic disk, an optical disc, a magneto-optical disc, or a semiconductor memory (including not only a drive of a removable medium but also a hard disk, a solid-state drive (SSD), a network attached storage (NAS), and the like). In addition, the connectivity 1321 may have an output device for images and sounds (a monitor, a speaker, or the like).

The camera 1322 is a module with a function for imaging subjects and obtaining image data of the subjects. Image data obtained from imaging of the camera 1322 is, for example, supplied to and encoded by the video processor 1332.

The sensor 1323 is a module with an arbitrary sensor function of, for example, a sound sensor, an ultrasonic sensor, a light sensor, a illuminance sensor, an infrared sensor, an image sensor, a rotation sensor, an angle sensor, an angular velocity sensor, a speed sensor, an acceleration sensor, an inclination sensor, a magnetism identification sensor, an impact sensor, or a temperature sensor. Data detected by the sensor 1323 is, for example, supplied to the application processor 1331 to be used by an application.

A configuration described as a module above may be realized as a processor, or conversely, a configuration described as a processor may be realized as a module.

In the video set 1300 configured as described above, the present technology can be applied to the video processor 1332 to be described below. Thus, the video set 1300 can be attained as a set to which the present technology has been applied.

[Configuration Example of a Video Processor]

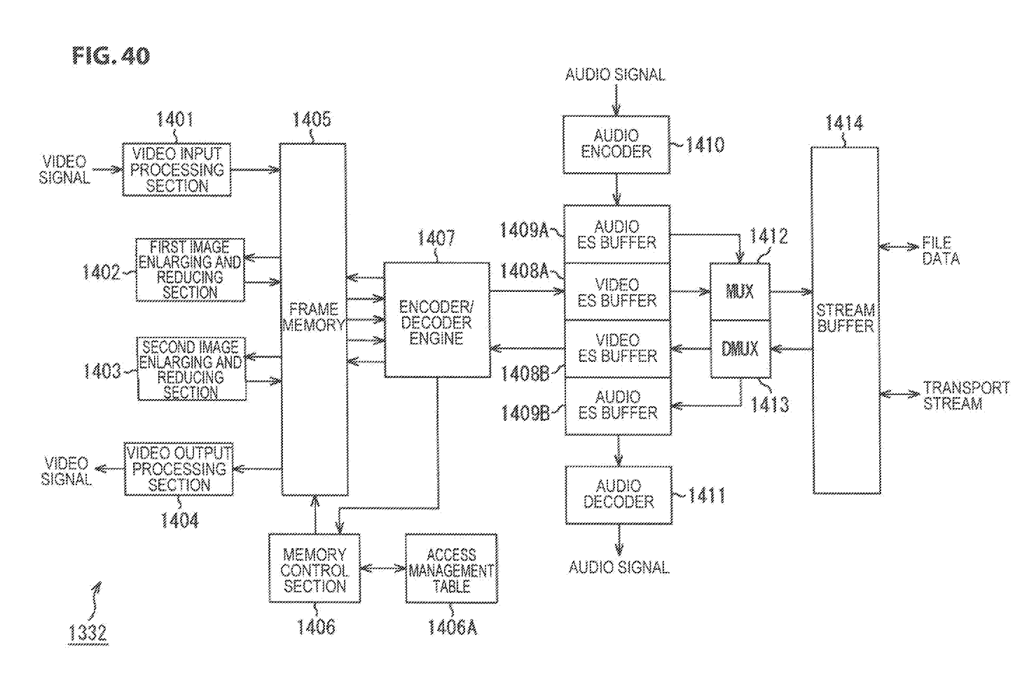

FIG. 40 shows an example of a schematic configuration of the video processor 1332 (of FIG. 39) to which the present technology has been applied.

In the example of FIG. 40, the video processor 1332 has a function of encoding input of received video signals and audio signals in a predetermined scheme, and a function of decoding encoded video data and audio data and reproducing and outputting video signals and audio signals.

As shown in FIG. 40, the video processor 1332 has a video input processing section 1401, a first image enlarging and reducing section 1402, a second image enlarging and reducing section 1403, a video output processing section 1404, a frame memory 1405, and a memory control section 1406. In addition, the video processor 1332 has an encoder/decoder engine 1407, video elementary stream (ES) buffers 1408A and 1408B, and audio ES buffers 1409A and 1409B. Further, the video processor 1332 has an audio encoder 1410, an audio decoder 1411, a multiplexer (MUX) 1412, a demultiplexer (DMUX) 1413, and a stream buffer 1414.

The video input processing section 1401 acquires video signals input from, for example, the connectivity 1321 (of FIG. 39) or the like, and converts them into digital image data. The first image enlarging and reducing section 1402 performs conversion of a format, image enlarging and reducing processes, and the like on the image data. The second image enlarging and reducing section 1403 performs image enlarging and reducing processes on the image data according to the format of the destination to which the data is output via the video output processing section 1404, or performs the same conversion, a format or image enlarging and reducing process, and the like as the first image enlarging and reducing section 1402. The video output processing section 1404 performs conversion of a format, conversion into an analog signal, or the like on the image data and outputs the data to, for example, the connectivity 1321 (of FIG. 39) as reproduced video signals.

The frame memory 1405 is a memory for image data shared by the video input processing section 1401, the first image enlarging and reducing section 1402, the second image enlarging and reducing section 1403, the video output processing section 1404, and the encoder/decoder engine 1407. The frame memory 1405 is realized as a semiconductor memory, for example, a DRAM, or the like.

The memory control section 1406 receives a synchronous signal from the encoder/decoder engine 1407 and controls access of writing and reading to the frame memory 1405 according to an access schedule to the frame memory 1405 which is written on an access managing table 1406A. The access managing table 1406A is updated by the memory control section 1406 according to a process executed by the encoder/decoder engine 1407, the first image enlarging and reducing section 1402, the second image enlarging and reducing section 1403, or the like.

The encoder/decoder engine 1407 performs an encoding process of image data and a decoding process of video streams that are data obtained by encoding image data. The encoder/decoder engine 1407, for example, encodes image data read from the frame memory 1405 and sequentially writes the data in the video ES buffer 1408A as video streams. In addition, the encoder/decoder engine, for example, sequentially reads video streams from the video ES buffer 1408B to decode the streams, and then sequentially writes the streams in the frame memory 1405 as image data. The encoder/decoder engine 1407 uses the frame memory 1405 during the encoding and decoding. In addition, the encoder/decoder engine 1407 outputs a synchronous signal to the memory control section 1406 at, for example, a timing at which a process is started for each macroblock.

The video ES buffer 1408A performs buffering on a video stream generated by the encoder/decoder engine 1407 and then supplies the data to the multiplexer (MUX) 1412. The video ES buffer 1408B performs buffering on a video stream supplied from the demultiplexer (DMUX) 1413 and then supplies the data to the encoder/decoder engine 1407.

The audio ES buffer 1409A performs buffering on an audio stream generated by the audio encoder 1410 and then supplies the data to the multiplexer (MUX) 1412. The audio ES buffer 1409B performs buffering on an audio stream supplied from the demultiplexer (DMUX) 1413 and then supplies the data to the audio decoder 1411.

The audio encoder 1410 performs, for example, digital conversion on an audio signal input from, for example, the connectivity 1321 (of FIG. 39) or the like, and encodes the signal in a predetermined scheme, for example, the MPEG audio scheme, the Audio Code Number 3 (AC3) scheme, or the like. The audio encoder 1410 sequentially writes audio streams that are data obtained by encoding audio signals in the audio ES buffer 1409A. The audio decoder 1411 decodes audio streams supplied from the audio ES buffer 1409B, performs conversion into, for example, analog signals, and supplies the result to, for example, the connectivity 1321 (of FIG. 39) or the like as reproduced audio signals.

The multiplexer (MUX) 1412 multiplexes video streams and audio streams. A multiplexing method (i.e., the format of the bit streams generated from multiplexing) is arbitrary. In addition, during multiplexing, the multiplexer (MUX) 1412 can also add predetermined header information or the like to the bit streams. That is, the multiplexer (MUX) 1412 can convert the format of streams through multiplexing. The multiplexer (MUX) 1412, for example, multiplexes video streams and audio streams to convert the streams into transport streams that are bit streams in the format for transfer. In addition, the multiplexer (MUX) 1412, for example, multiplexes video streams and audio streams to convert the streams into data in a file format for recording (file data).

The demultiplexer (DMUX) 1413 demultiplexes bit streams obtained by multiplexing video streams and audio streams using the method corresponding to multiplexing by the multiplexer (MUX) 1412. In other words, the demultiplexer (DMUX) 1413 extracts video streams and audio streams from bit streams read from the stream buffer 1414 (separates the bit streams into video streams and audio streams). In other words, the demultiplexer (DMUX) 1413 can convert the format of streams through demultiplexing (inverse conversion to conversion by the multiplexer (MUX) 1412). The demultiplexer (DMUX) 1413 can, for example, acquire transport streams supplied from, for example, the connectivity 1321, the broadband modem 1333, and the like (all of which are in FIG. 27) via the stream buffer 1414, and convert the streams into video streams and audio streams through demultiplexing. In addition, the demultiplexer (DMUX) 1413 can, for example, acquire file data read by the connectivity 1321 (of FIG. 39) from various recording media through the stream buffer 1414, and convert the data into video streams and audio streams through demultiplexing.

The stream buffer 1414 performs buffering on bit streams. The stream buffer 1414, for example, performs buffering on transport streams supplied from the multiplexer (MUX) 1412 and supplies the result to, for example, the connectivity 1321 or the broadband modem 1333 (all of which are in FIG. 39) at a predetermined timing or based on a request from outside or the like.

In addition, the stream buffer 1414, for example, performs buffering on file data supplied from the multiplexer (MUX) 1412, and supplies the result to, for example, the connectivity 1321 (of FIG. 39) or the like at a predetermined timing or based on a request from the outside or the like to be recorded in various recording media.

Furthermore, the stream buffer 1414, for example, performs buffering on transport streams acquired via, for example, the connectivity 1321 or the broadband modem 1333 (both of which are in FIG. 39) and supplies the result to the demultiplexer (DMUX) 1413 at a predetermined timing or based on a request from the outside or the like.

In addition, the stream buffer 1414, for example, performs buffering on file data of, for example, the connectivity 1321 (of FIG. 39) read from various recording media, and supplies the result to the demultiplexer (DMUX) 1413 at a predetermined timing or based on a request from the outside or the like.

Next, an example of an operation of the video processor 1332 configured as above will be described. For example, video signals input to the video processor 1332 from the connectivity 1321 (of FIG. 39) are converted into digital image data by the video input processing section 1401 in a predetermined format such as a Y:Cb:Cr format of 4:2:2, and then is sequentially written in the frame memory 1405. This digital image data is read by the first image enlarging and reducing section 1402 or the second image enlarging and reducing section 1403, undergoes format conversion to a predetermined format such as a Y:Cb:Cr format of 4:2:0 and an enlarging and reducing process, and is written in the frame memory 1405 again. This image data is encoded by the encoder/decoder engine 1407, and written in the video ES buffer 1408A as video streams.

In addition, audio signals input to the video processor 1332 from the connectivity 1321 (of FIG. 39) are encoded by the audio encoder 1410 and then written in the audio ES buffer 1409A as audio streams.

The video streams of the video ES buffer 1408A and the audio streams of the audio ES buffer 1409A are read and multiplexed by the multiplexer (MUX) 1412, and converted into transport streams, file data, or the like. The transport streams generated by the multiplexer (MUX) 1412 are buffered by the stream buffer 1414, and then output to an external network via, for example, the connectivity 1321 or the broadband modem 1333 (all of which are in FIG. 39). In addition, the file data generated by the multiplexer (MUX) 1412 is buffered by the stream buffer 1414, and then output to, for example, the connectivity 1321 (of FIG. 39) and recorded in various recording media.

In addition, the transport streams input to the video processor 1332 from an external network via, for example, the connectivity 1321 or the broadband modem 1333 (all of which are in FIG. 39) are buffered in the stream buffer 1414, and then demultiplexed by the demultiplexer (DMUX) 1413. In addition, the file data read from various recording media by, for example, the connectivity 1321 (in FIG. 39) or the like and input to the video processor 1332 is buffered in the stream buffer 1414, and then demultiplexed by the demultiplexer (DMUX) 1413. That is, the transport streams or the file data input to the video processor 1332 are separated into video streams and audio streams by the demultiplexer (DMUX) 1413.

The audio streams are supplied to the audio decoder 1411 via the audio ES buffer 1409B and decoded there, and thereby audio signals are reproduced. In addition, the video streams are written in the video ES buffer 1408B, and then sequentially read and decoded by the encoder/decoder engine 1407, and written in the frame memory 1405. Decoded image data is processed to be enlarged or reduced by the second image enlarging and reducing section 1403, and written in the frame memory 1405. Then, the decoded image is read by the video output processing section 1404, undergoes formation conversion to a predetermined format such as a Y:Cb:Cr format of 4:2:2, and further undergoes conversion to analog signals, and thereby video signals are reproduced for output.

When the present technology is to be applied to the video processor 1332 configured as described above, the present technology according to each embodiment described above may be applied to the encoder/decoder engine 1407. That is, for example, the encoder/decoder engine 1407 may have the function of the image processing device 11 (of FIG. 1), the image processing device 101 (of FIG. 2) according to the first embodiment, or the like. Thereby, the video processor 1332 can obtain the same effects as those described above with reference to FIGS. 1 to 33.

Note that, for the encoder/decoder engine 1407, the present technology (i.e., the function of the image processing device according to each embodiment described above) may be realized by hardware such as a logical circuit or the like, by software such as an embedded program or the like, or by both.

[Other Configuration Example of the Video Processor]

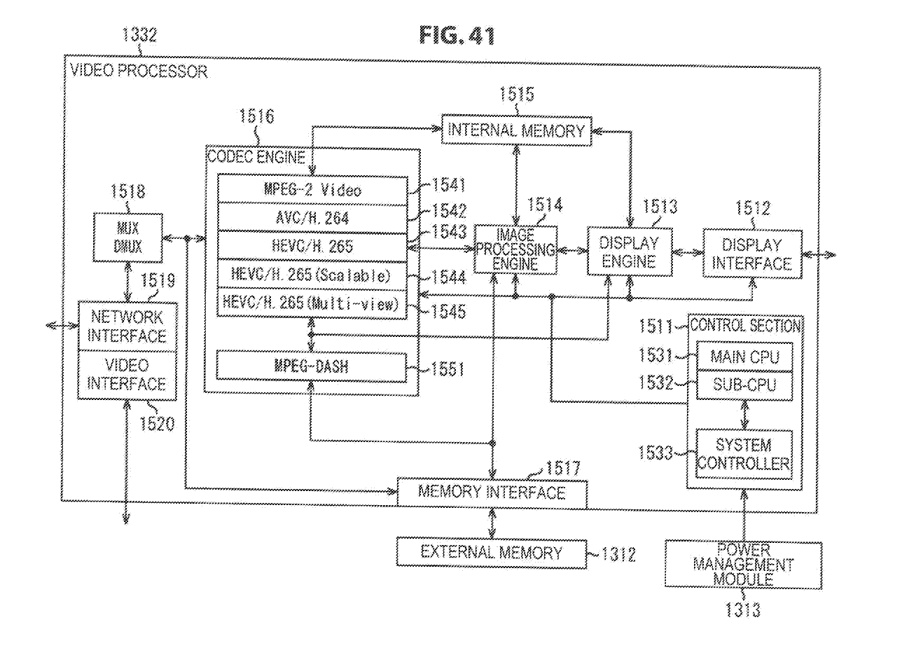

FIG. 41 shows another example of the schematic configuration of the video processor 1332 (of FIG. 39) to which the present technology has been applied. In the example of FIG. 41, the video processor 1332 has a function of encoding and decoding video data in a predetermined scheme.

To be more specific, the video processor 1332 has a control section 1511, a display interface 1512, a display engine 1513, an image processing engine 1514, and an internal memory 1515 as shown in FIG. 41. In addition, the video processor 1332 has a codec engine 1516, a memory interface 1517, a multiplexing/demultiplexing section (MUX/DMUX) 1518, a network interface 1519, and a video interface 1520.

The control section 1511 controls operations of respective processing sections included in the video processor 1332 such as the display interface 1512, the display engine 1513, the image processing engine 1514, the codec engine 1516, and the like.

The control section 1511 has, for example, a main CPU 1531, a sub-CPU 1532, and a system controller 1533 as shown in FIG. 41. The main CPU 1531 executes a program for controlling operations of respective processing sections included in the video processor 1332, and the like. The main CPU 1531 generates control signals according to the program and the like, and supplies the signals to the respective processing sections (i.e., controls operations of the respective processing sections). The sub-CPU 1532 plays an auxiliary role of the main CPU 1531. For example, the sub-CPU 1532 executes a child process, a sub-routine, or the like of a program executed by the main CPU 1531, and the like. The system controller 1533 controls operations of the main CPU 1531 and the sub-CPU 1532 such as designating programs to be executed by the main CPU 1531 and the sub-CPU 1532.

The display interface 1512 converts image data, for example, image data of the connectivity 1321 (of FIG. 39) into analog signals under control of the control section 1511, and outputs the signals to a monitor device of the connectivity 1321 (of FIG. 39) or the like as reproduced video signals or as the image data of digital data.

The display engine 1513 performs various conversion processes such as format conversion, size conversion, color gamut conversion, and the like on the image data under control of the control section 1511 to meet the specifications of hardware such as a monitor device on which images are displayed and the like.

The image processing engine 1514 performs predetermined image processing, for example, a filtering process or the like for improving image quality on the image data under control of the control section 1511.

The internal memory 1515 is a memory provided inside the video processor 1332 which is shared by the display engine 1513, the image processing engine 1514, and the codec engine 1516. The internal memory 1515 is used in, for example, exchanging data between the display engine 1513, the image processing engine 1514, and the codec engine 1516. The internal memory 1515, for example, stores data supplied from the display engine 1513, the image processing engine 1514, or the codec engine 1516, and supplies the data to the display engine 1513, the image processing engine 1514, or the codec engine 1516 when necessary (for example, according to a request). This internal memory 1515 may be realized by any storing device; however, it is mostly used to store a small volume of data such as image data or parameters in units of blocks, and thus it is desirable to realize the memory with a semiconductor memory which has a relative small capacity (in comparison to, for example, the external memory 1312) but has a high response speed, for example, a static random access memory (SRAM).

The codec engine 1516 performs processes relating to encoding and decoding of image data. An encoding and decoding scheme applicable to this codec engine 1516 is arbitrary, and the number thereof may be 1 or plural. The codec engine 1516, for example, may have codec functions of a plurality of encoding and decoding schemes, and may perform encoding of image data or decoding of encoded data using one selected therefrom.

In the example shown in FIG. 41, the codec engine 1516 has, for example, MPEG-2 video 1541, AVC/H.264 1542, HEVCH.265 1543, HEVC/H.265 (scalable) 1544, H-EVC/H.265 (multi-view) 1545, and MPEG-DASH 1551 as functional blocks for codec-related processes.

The MPEG-2 video 1541 is a functional block for encoding or decoding image data in the MPEG-2 scheme. The AVC/H.264 1542 is a functional block for encoding or decoding image data in the AVC scheme. The HEVC/H.265 1543 is a functional block for encoding or decoding image data in the HEVC scheme. The HEVC/H.265 (scalable) 1544 is a functional block for scalably encoding or decoding image data in the HEVC scheme. The HEVC/H.265 (multi-view) 1545 is a functional block for performing multi-view encoding or decoding on image data in the HEVC scheme.

The MPEG-DASH 1551 is a functional block for transmitting and receiving image data in the MPEG-Dynamic Adaptive Streaming over HTTP (MPEG-DASH) scheme. MPEG-DASH is a video streaming technique over HyperText Transfer Protocol (HTTP), one characteristic of which is that proper pieces are selected in units of segments from a plurality of encoded pieces of prepared data which have different resolutions and transferred. The MPEG-DASH 1551 performs generation of streams and control of transferring streams based on the standard, and uses the above-described MPEG-2 video 1541 to HEVC/H.265 (multi-view) 1545 for encoding and decoding of image data.

The memory interface 1517 is an interface for the external memory 1312. Data supplied from the image processing engine 1514 and the codec engine 1516 is supplied to the external memory 1312 via the memory interface 1517. In addition, data read from the external memory 1312 is supplied to the video processor 1332 (the image processing engine 1514 or the codec engine 1516) via the memory interface 1517.

The multiplexing/demultiplexing section (MUX/DMUX) 1518 performs multiplexing and demultiplexing of various kinds of data relating to images such as bit streams of encoded data, image data, and video signals. A method for such multiplexing and demultiplexing is arbitrary. The multiplexing/demultiplexing section (MUX/DMUX) 1518, for example, can not only organize a plurality of data pieces to be one, but can also add predetermined header information or the like to the data during multiplexing. In addition, during demultiplexing, the multiplexing/demultiplexing section (MUX/DMUX) 1518 can not only divide one piece of data into a plurality of pieces but can also add predetermined header information or the like to each piece of the divided data. That is, the multiplexing/demultiplexing section (MUX/DMUX) 1518 can convert the format of data through multiplexing and demultiplexing. The multiplexing/demultiplexing section (MUX/DMUX) 1518, for example, can multiplex bit streams to convert them into transport streams that are bit streams in a transfer format or data in a file format (file data) for recording. Of course, inverse conversion thereto can also be possible through demultiplexing.

The network interface 1519 is an interface for, for example, the broadband modem 1333 and the connectivity 1321 (both of which are in FIG. 39), and the like. The video interface 1520 is an interface for, for example, the connectivity 1321 and the camera 1322 (both of which are in FIG. 39), and the like.

Next, an example of an operation of the video processor 1332 configured as above will be described. When a transport stream is received from an external network via the connectivity 1321 or the broadband modem 1333 (all of which are in FIG. 39), for example, the transport stream is supplied to the multiplexing/demultiplexing section (MUX/DMUX) 1518 via the network interface 1519 and demultiplexed there, and then decoded by the codec engine 1516. Image data obtained from the decoding of the codec engine 1516 undergoes predetermined image processing by the image processing engine 1514, undergoes predetermined conversion by the display engine 1513, and is supplied to, for example, the connectivity 1321 (of FIG. 39) via the display interface 1512, and images thereof are displayed on a monitor. In addition, the image data obtained from the decoding by the codec engine 1516, for example, is encoded again by the codec engine 1516, multiplexed by the multiplexing/demultiplexing section (MUX/DMUX) 1518 to be converted into file data, output to, for example, the connectivity 1321 (of FIG. 39) via the video interface 1520, and then recorded in various recording media.

Furthermore, file data of encoded data obtained by encoding image data read from a recording medium not illustrated by the connectivity 1321 (of FIG. 39), for example, is supplied to the multiplexing/demultiplexing section (MUX/DMUX) 1518 via the video interface 1520 to be demultiplexed, and decoded by the codec engine 1516. Image data obtained from the decoding of the codec engine 1516 undergoes predetermined image processing by the image processing engine 1514, undergoes predetermined conversion by the display engine 1513, and is supplied to, for example, the connectivity 1321 (of FIG. 39) via the display interface 1512, and then images thereof are displayed on a monitor. In addition, the image data obtained from the decoding of the codec engine 1516, for example, is encoded again by the codec engine 1516, multiplexed by the multiplexing/demultiplexing section (MUX/DMUX) 1518 to be converted into transport streams, supplied to, for example, the connectivity 1321, the broadband modem 1333 (all of which are in FIG. 39), or the like via the network interface 1519, and then transmitted to another device that is not illustrated.

Note that exchange of image data and other data between respective processing sections included in the video processor 1332 is performed using, for example, the internal memory 1515 and the external memory 1312. In addition, the power management module 1313 controls power supply to, for example, the control section 1511.

When the present technology is to be applied to the video processor 1332 configured as above, the present technology according to each embodiment described above may be applied to the codec engine 1516. That is, the codec engine 1516 may be set, for example, to have a functional block which realizes the image encoding device 1 (of FIG. 1) and image decoding device 101 (of FIG. 2) according to the first embodiment Thereby, the video processor 1332 can obtain the same effects as those described above with reference to FIGS. 1 to 33.

Note that, in the codec engine 1516, the present technology (i.e., the function of the image encoding device and the image decoding device according to each embodiment described above) may be realized by hardware such as a logical circuit or the like, by software such as an embedded program or the like, or by both.

Although two configurations of the video processor 1332 have been exemplified above, a configuration of the video processor 1332 is arbitrary, and may be one other than the two examples described above. In addition, the video processor 1332 may be configured as one semiconductor chip or as a plurality of semiconductor chips. For example, a plurality of semiconductors may be laminated to form a 3-dimensional laminated LSI chip. In addition, the processor may be realized by a plurality of LSI chips.

[Application Example of Devices]

The video set 1300 can be incorporated into various devices which process image data. For example, the video set 1300 can be incorporated into the television device 900 (of FIG. 35), the mobile telephone 920 (of FIG. 36), the recording and reproduction device 940 (of FIG. 37), the imaging device 960 (of FIG. 38), and the like. By being incorporated with the video set 1300, these devices can obtain the same effects as those described above with reference to FIGS. 1 to 33.

Note that even a part of each configuration of the video set 1300 described above can be implemented as a configuration to which the present technology is applied as long as the part includes the video processor 1332. For example, the video processor 1332 alone can be implemented as a video processor to which the present technology is applied. In addition, the processor indicated by the dotted line 1341, the video module 1311, and the like described above, for example, can be implemented as a processor, a module, and the like to which the present technology is applied. Furthermore, for example, a combination of the video module 1311, the external memory 1312, the power management module 1313, and the front-end module 1314 can also be implemented as the video unit 1361 to which the present technology is applied. All of the configurations can obtain the same effects as those described above with reference to FIGS. 1 to 33.

That is, any configuration which includes the video processor 1332 can be incorporated into various devices which process image data, like the video set 1300. For example, the video processor 1332, the processor indicated by the dotted line 1341, the video module 1311, or the video unit 1361 can be incorporated with the television device 900 (of FIG. 35), the mobile telephone 920 (of FIG. 36), the recording and reproduction device 940 (of FIG. 37), the imaging device 960 (of FIG. 38), and the like. In addition, by being incorporated with any configuration to which the present technology has been applied, these devices can obtain the same effects as those described above with reference to FIGS. 1 to 33, like the video set 1300.

Note that, in the present specification, the cases in which various kinds of information, for example, quadtree information (hierarchical block split information), prediction mode information, motion vector information, macroblock information, an SAO parameter, and the like are multiplexed to be encoded streams and transmitted from the encoding side to the decoding side have been described. The method of transmitting these pieces of information however is not limited to such example. For example, these pieces of information may be transmitted or recorded as separate data associated with the encoded bit streams without being multiplexed to the encoded bit streams. Here, the term “association” means to allow the image included in a bit stream (the image may be a part of an image such as a slice or a block) and the information corresponding to the image to establish a link when decoding. Namely, the information may be transmitted on a different transmission path from that of the image (or the bit stream). In addition, the information may also be recorded in a different recording medium (or a different recording area in the same recording medium) from that of the image (or the bit stream). Furthermore, the information and the image (or the bit stream) may be associated with each other in an arbitrary unit such as a plurality of frames, one frame, or a portion within a frame.

The preferred embodiments of the present disclosure have been described above with reference to the accompanying drawings, whilst the present disclosure is not limited to the above examples, of course. A person skilled in the art may find various alternations and modifications within the scope of the appended claims, and it should be understood that they will naturally come under the technical scope of the present disclosure.

(1)

An image processing device including;

an image processing section configured to perform image processing on an image generated by performing a decoding process on a bit stream in units of blocks which have a hierarchical structure using an encoding parameter to be used in performing encoding in units of blocks which have a hierarchical structure.

(2)

The image processing device according to (1), wherein the encoding parameter is a parameter which indicates a size of a block.

(3)

The image processing device according to (2),

wherein the encoding parameter is a parameter which indicates a depth of a layer.

(4)

The image processing device according to (3),

wherein the encoding parameter is split-flag.

(5)

The image processing device according to (1),

wherein the encoding parameter is a parameter of an adaptive offset filter.

(6)

The image processing device according to (5),

wherein the encoding parameter is a parameter which indicates edge offset or band offset.

(7)

The image processing device according to any of (1) to (4),

wherein the image processing section performs image processing using an encoding block size map generated from the encoding parameter.

(8)

The image processing device according to any of (1) to (4), and (7),

wherein the image processing section includes
an area detecting section configured to generate area information by detecting a boundary of an area from the encoding parameter, and
a high image quality processing section configured to perform a high image quality process on the image based on the area information detected by the area detecting section.
   (9)

The image processing device according to (8),

wherein the area detecting section generates area information which includes information that indicates a dynamic body area or a standstill area.

(10)

The image processing device according to (9),

wherein the area detecting section generates the area information using motion vector information obtained by performing a decoding process on the bit stream.

(11)

The image processing device according to any of (8) to (10),

wherein the image processing section further includes an area deciding section configured to generate area information which indicates an occlusion or an excessively deformed area from the encoding parameter, and

wherein the high image quality processing section performs a high image quality process on the image based on the area information detected by the area detecting section and the area information generated by the area deciding section.

(12)

The image processing device according to any of (8) to (11),

wherein the high image quality process is a process which uses an in-screen correlation.

(13)

The image processing device according to any of (8) to (12),

wherein the high image quality process is noise reduction, a high frame-rate process, or a multi-frame super resolution process.

(14)

The image processing device according to (1),

wherein the image processing section includes
an area deciding section configured to generate area information which indicates an occlusion or an excessively deformed area from the encoding parameter, and
a high image quality processing section configured to perform a high image quality process on the image based on the area information decided by the area deciding section.
   (15)

The image processing device according to any of (1) to (14), further including:

a decoding section configured to perform a decoding process on the bit stream to generate the image and output the encoding parameter,

wherein the image processing section performs image processing on an image generated by the decoding section using the encoding parameter output by the decoding section.

(16)

The image processing device according to (15),

wherein the decoding section further includes
an adaptive offset filtering section configured to perform an adaptive offset process on the image.
   (17)

An image processing method including:

performing, by an image processing device, image processing on an image generated by performing a decoding process on a bit stream in units of blocks which have a hierarchical structure, using an encoding parameter to be used in performing encoding in units of blocks which have a hierarchical structure.

### REFERENCE SIGNS LIST

101 image processing device
111 decoding section
112 image processing section
121 MV converter
122 dynamic body area detector
123 dynamic image processor
181 boundary block determining section
182 labeling section
183 dynamic body standstill determining section
201 image processing device
211 image processing section
221 area splitting section
231 object boundary detector
232 time axis processing non-adaptive area deciding section
233 time axis processing area decoding section

1. An image processing device comprising:
an image processing section configured to perform image processing on an image generated by performing a decoding process on a bit stream in units of blocks which have a hierarchical structure using an encoding parameter to be used in performing encoding in units of blocks which have a hierarchical structure.

2. The image processing device according to claim 1,
wherein the encoding parameter is a parameter which indicates a size of a block.

3. The image processing device according to claim 2,
wherein the encoding parameter is a parameter which indicates a depth of a layer.

4. The image processing device according to claim 3,
wherein the encoding parameter is split_flag.

5. The image processing device according to claim 1,
wherein the encoding parameter is a parameter of an adaptive offset filter.

6. The image processing device according to claim 5,
wherein the encoding parameter is a parameter which indicates edge offset or band offset.

7. The image processing device according to claim 1,
wherein the image processing section performs image processing using an encoding block size map generated from the encoding parameter.

8. The image processing device according to claim 1,
wherein the image processing section includes
an area detecting section configured to generate area information by detecting a boundary of an area from the encoding parameter, and
a high image quality processing section configured to perform a high image quality process on the image based on the area information detected by the area detecting section.

9. The image processing device according to claim 8,
wherein the area detecting section generates area information which includes information that indicates a dynamic body area or a standstill area.

10. The image processing device according to claim 9,
wherein the area detecting section generates the area information using motion vector information obtained by performing a decoding process on the bit stream.

11. The image processing device according to claim 8,
wherein the image processing section further includes an area deciding section configured to generate area information which indicates an occlusion area or an excessively deformed area from the encoding parameter, and
wherein the high image quality processing section performs a high image quality process on the image based on the area information detected by the area detecting section and the area information generated by the area deciding section.

12. The image processing device according to claim 8,
wherein the high image quality process is a process which uses an in-screen correlation.

13. The image processing device according to claim 12,
wherein the high image quality process is noise reduction, a high frame-rate process, or a multi-frame super resolution process.

14. The image processing device according to claim 1,
wherein the image processing section includes
an area deciding section configured to generate area information which indicates an occlusion area or an excessively deformed area from the encoding parameter, and
a high image quality processing section configured to perform a high image quality process on the image based on the area information decided by the area deciding section.

15. The image processing device according to claim 1, further comprising:
a decoding section configured to perform a decoding process on the bit stream to generate the image and output the encoding parameter,
wherein the image processing section performs image processing on an image generated by the decoding section using the encoding parameter output by the decoding section.

16. The image processing device according to claim 15,
wherein the decoding section further includes
an adaptive offset filtering section configured to perform an adaptive offset process on the image.

17. An image processing method comprising:
performing, by an image processing device, image processing on an image generated by performing a decoding process on a bit stream in units of blocks which have a hierarchical structure, using an encoding parameter to be used in performing encoding in units of blocks which have a hierarchical structure.
